(19) United States
(12) Patent Application Publication
(10) Pub. No.: US 2025/0354032 A1
(43) Pub. Date: Nov. 20, 2025

(54) POLISHING COMPOSITION

(71) Applicant: FUJIMI INCORPORATED, Kiyosu-shi (JP)

(72) Inventors: Masaki Tada, Kiyosu-shi (JP); Akane Kumayama, Kiyosu-shi (JP); Noriyuki Tanaka, Kiyosu-shi (JP)

(73) Assignee: FUJIMI INCORPORATED, Kiyosu-shi (JP)

(21) Appl. No.: 19/200,906

(22) Filed: May 7, 2025

(30) Foreign Application Priority Data
May 20, 2024 (JP) 2024-081896

(51) Int. Cl. C09G 1/02; C09K 3/14

(52) U.S. Cl. CPC C09G 1/02; C09K 3/1409

(57) ABSTRACT

An object of the present invention is to provide a new polishing composition that can reduce remaining of an object to be polished, which has to be polished, such as polysilicon, and suppress recesses. Provided is a polishing composition comprising colloidal silica; an alkali metal salt; polyalkylene glycol; at least one selected from the group consisting of a cellulose derivative and a polymer compound X; and water, the polishing composition having a pH of 9.0 to 11.5, the polymer compound X containing a repeating unit represented by the following formula (1):

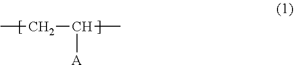

wherein A is a group selected from at least one kind of the followings:

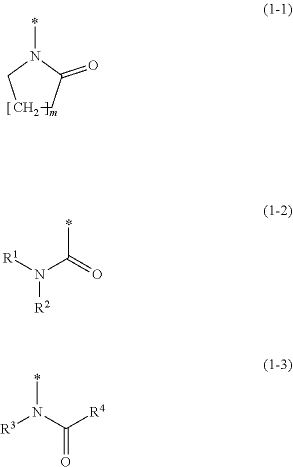

wherein m is an integer of 1 to 5; R¹ to R⁴ are each independently selected from the group consisting of a hydrogen atom and an alkyl group having 1 to 4 carbon atoms, wherein R¹ and R² may form a ring and, in a case where the ring is formed, at least one oxygen atom may be contained in the ring, and wherein R³ and R⁴ may form a ring and, in a case where the ring is formed, at least one oxygen atom may be contained in the ring; and at least one oxygen atom may be contained in a ring in the formula 1-1,
the polymer compound X optionally further containing a repeating unit represented by the following formula (2):

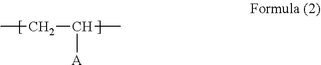

wherein A is a hydroxy group,
(i) wherein the polishing composition is used in a step of polishing a second layer to expose a first layer in an object to be polished including the first layer provided with a recess portion and the second layer formed to fill the inside of the recess portion, and wherein the first layer is selected from the group consisting of a layer having an oxygen-silicon bond or a layer having a nitrogen-silicon bond, and the second layer has a silicon-silicon bond; and/or (ii) wherein the number of silanol groups in the colloidal silica is 6/nm² or more and 22/nm² or less.

### BACKGROUND

### 1. Technical Field

The present invention relates to a polishing composition.

### 2. Description of Related Arts

In the field of CMP, polishing is sometimes performed in a condition where a silicon dioxide film provided with a recess portion and a polysilicon film formed to fill the inside of the recess portion are arranged and the silicon dioxide film is used as a stopper film.

As an index indicating how easily the polysilicon film is polished with respect to the silicon dioxide film, a selectivity that is a ratio of a rate at which the polysilicon film is polished to a rate at which the silicon dioxide film is polished is used. The selectivity is determined by dividing the rate at which the polysilicon film is polished by that of the silicon dioxide film. In order for the silicon dioxide film to function as a stopper layer, it is preferable that the selectivity is large. For example, Patent Literature 1 provides a polishing composition containing a polishing material such as silicon dioxide and water and optionally further containing a basic organic compound such as tetramethylammonium hydroxide, in order to provide a polishing composition that can obtain a large selectivity and that causes less surface defects.

Silicon nitride is sometimes used as the stopper film as well, and, it is also preferable that, when silicon nitride is used as the stopper film, a ratio of a polishing removal rate of materials other than the silicon nitride to a polishing removal rate of the silicon nitride is large. As an example in which silicon nitride is used as a stopper film, Patent Literature 2 discloses a composition for chemical mechanical polishing formed of silica; aminophosphonic acid; polysaccharide; a tetraalkylammonium salt; a bicarbonate; a compound containing an azole ring; potassium hydroxide as an optional component; and water, and having a pH of 7 to 11.

### CITATION LIST

### Patent Literature

[Patent Literature 1] Japanese Patent Laid-Open No. 10-321569
[Patent Literature 2] Japanese Translation of PCT International Application Publication No. 2014-505358

### SUMMARY

The present inventors have found the fact that, in the process of developing a new polishing composition, an object to be polished, which has to be polished, such as polysilicon, remains or recesses occur after polishing even if the selectivity is controlled with the conventional technology.

An object of the present invention is to provide a new polishing composition that can reduce remaining of an object to be polished, which has to be polished, such as polysilicon, and suppress recesses.

An aspect of the present invention is:
a polishing composition comprising colloidal silica; an alkali metal salt; polyalkylene glycol; at least one selected from the group consisting of a cellulose derivative and a polymer compound X; and water, the polishing composition having a pH of 9.0 to 11.5,
the polymer compound X containing a repeating unit represented by the following formula (1):

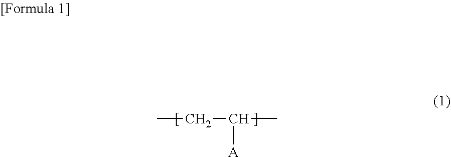

wherein A is a group selected from at least one kind of the followings:

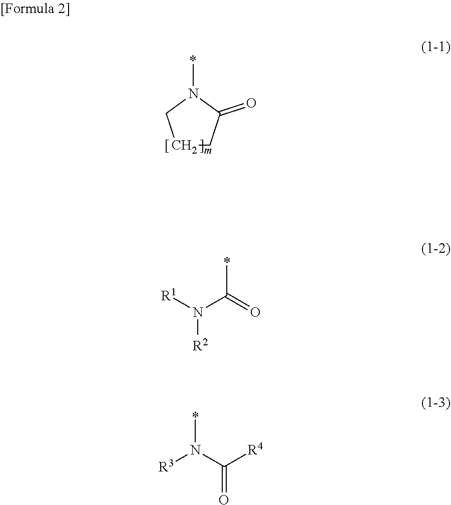

wherein m is an integer of 1 to 5; R¹ to R⁴ are each independently selected from the group consisting of a hydrogen atom and an alkyl group having 1 to 4 carbon atoms, wherein R¹ and R² may form a ring and, in a case where the ring is formed, at least one oxygen atom may be contained in the ring, and wherein R³ and R⁴ may form a ring and, in a case where the ring is formed, at least one oxygen atom may be contained in the ring; and at least one oxygen atom may be contained in a ring in the formula 1-1,
the polymer compound X optionally further containing a repeating unit represented by the following formula (2):

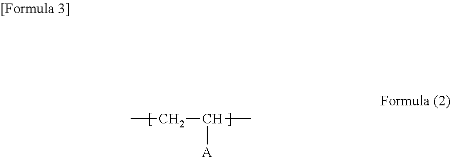

wherein A is a hydroxy group,
(i) wherein the polishing composition is used in a step of polishing a second layer to expose a first layer in an object to be polished including the first layer provided with a recess portion and the second layer formed to fill the inside of the recess portion, and wherein the first layer is selected from the group consisting of a layer having an oxygen-silicon bond or a layer having a nitrogen-silicon bond, and the second layer has a silicon-silicon bond; and/or (ii) wherein the number of silanol groups in the colloidal silica is 6/nm² or more and 22/nm² or less.

According to the present invention, a new polishing composition that can reduce remaining of an object to be polished, which has to be polished, such as polysilicon, and suppress recesses can be provided.

### BRIEF DESCRIPTION OF THE DRAWINGS

FIG. 1 is a schematic cross-sectional view of an object to be polished before polishing;

FIG. 2 is a schematic cross-sectional view of a polished object after being ideally polished;

FIG. 3 is a schematic cross-sectional view of a polished object which is not ideally polished and in which recesses occur as defects;

FIG. 4 is a schematic cross-sectional view of a polished object which is not ideally polished and in which an object to be polished, which has to be polished, remains as a defect; and

FIG. 5 is a schematic cross-sectional view of a polished object in which defects in FIGS. 3 and 4 occur simultaneously.

### DETAILED DESCRIPTION

In the present specification, the phrase “X to Y” is used in the meaning that the numerical values described in the first and the last of the phrase (X and Y) are included as the lower limit and the upper limit and, therefore, the phrase “X to Y” means “X or more and Y or less”. When a plurality of “X to Y” are described, for example, when “X1 to Y1, or X2 to Y2” is described, the disclosure of each numerical value as the upper limits, the disclosure of each numerical value as the lower limits, and the disclosure of the combination of those upper and lower limits are all included (that is, the lawful basis for the amendment). Specifically, the amendment to X1 or more, amendment to Y2 or less, amendment to X1 or less, amendment to Y2 or more, amendment to X1 to X2, amendment to X1 to Y2, or the like should all be considered legal. The phrase “X or more” means X or more than X and, therefore, the phrase “X or more” includes the meaning of “more than X”. In the same manner, the phrase “Y or less” means Y or less than Y and, therefore, the phrase “Y or less” includes the meaning of “less than Y”. Unless otherwise specified, operations and measurements of physical properties and the like are measured under the conditions of room temperature (20 to 25° C.)/relative humidity of 40 to 50% RH. The concentration described in the present specification may be a concentration at POU (point of use) or a concentration before dilution to the POU concentration. The dilution ratio may be 2 to 10 times. It should also be understood that all embodiments and combinations of descriptions disclosed in the present specification are disclosed in this application. That is, it should be understood that it can be a basis for the amendment. When the content or concentration of each component is described, it can be the total amount when two or more kinds thereof are included.

### <Polishing Composition>

An aspect of the present invention is a polishing composition comprising colloidal silica; an alkali metal salt; polyalkylene glycol; at least one selected from the group consisting of a cellulose derivative and a polymer compound X; and water, the polishing composition having a pH of 9.0 to 11.5, the polymer compound X containing a repeating unit represented by the following formula (1):

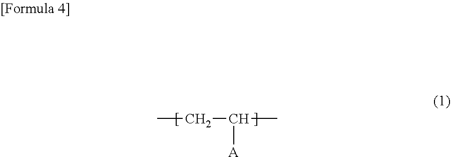

wherein A is a group selected from at least one kind of the followings:

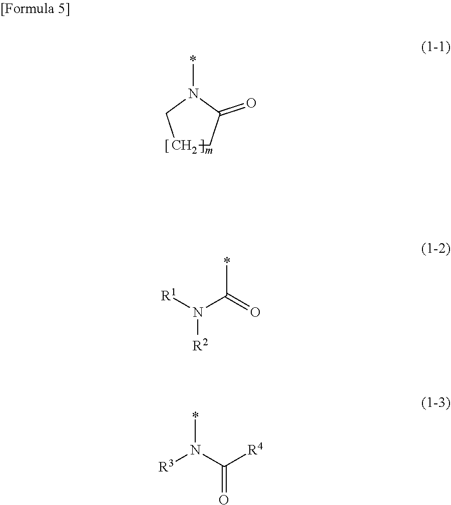

wherein m is an integer of 1 to 5; R¹ to R⁴ are each independently selected from the group consisting of a hydrogen atom and an alkyl group having 1 to 4 carbon atoms, wherein R¹ and R² may form a ring and, in a case where the ring is formed, at least one oxygen atom may be contained in the ring, and wherein R³ and R⁴ may form a ring and, in a case where the ring is formed, at least one oxygen atom may be contained in the ring; and at least one oxygen atom may be contained in a ring in the formula 1-1,
the polymer compound X optionally further containing a repeating unit represented by the following formula (2):

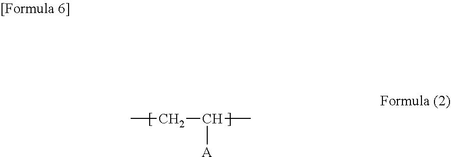

wherein A is a hydroxy group,
(i) wherein the polishing composition is used in a step of polishing a second layer to expose a first layer in an object to be polished including the first layer provided with a recess portion and the second layer formed to fill the inside of the recess portion, and wherein the first layer is selected from the group consisting of a layer having an oxygen-silicon bond or a layer having a nitrogen-silicon bond, and the second layer has a silicon-silicon bond; and/or (ii) wherein the number of silanol groups in the colloidal silica is 6/nm² or more and 22/nm² or less. With the aspect, a new polishing composition that can reduce remaining of an object to be polished, which has to be polished, such as polysilicon, and suppress recesses can be provided.

It is considered that the mechanisms that cause such a technical effect to exhibit are as follows. In a field in which the pH is alkaline, the polishing composition becomes rich in hydroxide ions (OH⁻), whereby the surface of the object to be polished having a silicon-silicon bond such as polysilicon turns into a silanol group (SiOH). At the time of polishing, reaction between the object to be polished that has turned into a silanol group (SiOH) and the colloidal silica in which the number of silanol groups falls within the above range is promoted by hydrogen bonding, thereby reducing remaining on a pattern wafer. It is supposed that, by using an alkali metal salt, excessive etching to the object to be polished having a silicon-silicon bond is suppressed, whereby the effect of suppressing recesses is exhibited. It is supposed that, in addition to this, when the cellulose derivative and/or the polymer compound X in the polishing composition is adsorbed by the surface of the polysilicon, the surface of the polysilicon is protected, whereby occurrence of recesses is further suppressed. On the other hand, it is considered that, although there is a possibility that the cellulose derivative and/or the polymer compound X prevents the silicon or the like locally remaining on the pattern wafer from being removed to increase remaining such as silicon, presence of polyalkylene glycol having a relatively low adsorption force to silicon or the like suppresses it. That is, it is considered that, with the combination of the above plurality of mechanisms, the polishing composition according to the present invention achieves both of reducing remaining of an object to be polished, which has to be polished, such as polysilicon, and suppressing recesses in a high level. However, as the mechanisms are mere suppositions and, therefore, the mechanisms do not limit the technical scope of the present invention.

### [Abrasive Grains]

The polishing composition of an aspect of the present invention contains colloidal silica as abrasive grains. The abrasive grains have a function of mechanically polishing an object to be polished. The colloidal silica can be produced by a sol-gel method. For example, the colloidal silica can be obtained by performing a hydrolysis/condensation reaction using a hydrolyzable silicon compound (for example, alkoxysilane or a derivative thereof) as a raw material.

According to an embodiment of the present invention, the number of silanol groups in the colloidal silica is 6/nm² or more and 22/nm² or less. Although the detailed mechanism is unclear, surprisingly, remaining of an object to be polished, which has to be polished, such as polysilicon, is reduced, and furthermore, recesses are suppressed by using a colloidal silica having 6/nm² or more and 22/nm² or less silanol groups. In other words, when the number of silanol groups of the colloidal silica is less than 6/nm² or more than 22/nm², there is a possibility that remaining of the object to be polished, which has to be polished, such as polysilicon, increases, and recesses are promoted. Examples of the method of controlling the number of silanol groups in the colloidal silica to 6/nm² or more and 22/nm² or less include a hydrothermal treatment of a dispersion containing colloidal silica. As conditions of the hydrothermal treatment, the dispersion containing colloidal silica is heat-treated at a temperature of, for example, 100° C. to 200° C. for 30 to 60 minutes.

According to an embodiment of the present invention, the number of silanol groups in the colloidal silica is 6.1/nm² or more, 6.2/nm² or more, 6.3/nm² or more, 6.4/nm² or more, 6.5/nm² or more, 6.6/nm² or more, more than 6.6/nm², 6.7/nm² or more, 6.8/nm² or more, 6.9/nm² or more, 7.0/nm² or more, 7.1/nm² or more, 7.2/nm² or more, 7.3/nm² or more, 7.4/nm² or more, 7.5/nm² or more, 7.6/nm² or more, 7.7/nm² or more, 7.8/nm² or more, 9/nm² or more, 10/nm² or more, 12/nm² or more, 14/nm² or more, or 16/nm² or more.

According to an embodiment of the present invention, the number of silanol groups in the colloidal silica is 21/nm² or less, 20/nm² or less, 19/nm² or less, 18/nm² or less, less than 17.5/nm², 17/nm² or less, 16/nm² or less, 15/nm² or less, 14/nm² or less, 13/nm² or less, 12/nm² or less, 11/nm² or less, 10/nm² or less, 9/nm² or less, 8/nm² or less, or 7/nm² or less. The method of measuring the number of silanol groups is the method described in EXAMPLES.

According to an embodiment of the present invention, a pulsed NMR specific surface area of the colloidal silica is 40 m²/g or less. According to an embodiment of the present invention, the pulsed NMR specific surface area of the colloidal silica is 39 m²/g or less, 38 m²/g or less, 37 m²/g or less, 36 m²/g or less, 35 m²/g or less, 34 m²/g or less, 33 m²/g or less, 32 m²/g or less, 31 m²/g or less, 30 m²/g or less, 29 m²/g or less, 28 m²/g or less, 27 m²/g or less, 26 m²/g or less, 25 m²/g or less, or 24 m²/g or less. According to an embodiment of the present invention, the pulsed NMR specific surface area of the colloidal silica is 10 m²/g or more, 15 m²/g or more, or 20 m²/g or more. The method of measuring the pulsed NMR specific surface area of the abrasive grains (particularly colloidal silica) is the method described in EXAMPLES. The pulsed NMR specific surface area of the colloidal silica can be controlled by increasing or decreasing the number of protons of the colloidal silica surface functional group since an aspect in which the relaxation rate of proton resonance changes depending on the amount of molecules adsorbed on the solid surface or the like is measured.

According to an embodiment of the present invention, the lower limit of the average primary particle size of the abrasive grains (particularly, colloidal silica) is 60 nm or more, 70 nm or more, more than 70 nm, 71 nm or more, 72 nm or more, 73 nm or more, 74 nm or more, 75 nm or more, 76 nm or more, 77 nm or more, 78 nm or more, 79 nm or more, 80 nm or more, 81 nm or more, 82 nm or more, 83 nm or more, 84 nm or more, 85 nm or more, 86 nm or more, 87 nm or more, 88 nm or more, 89 nm or more, or 95 nm or more.

According to an embodiment of the present invention, the upper limit of the average primary particle size of the abrasive grains (particularly, colloidal silica) is 110 nm or less, less than 100 nm, 99 nm or less, 98 nm or less, 97 nm or less, 96 nm or less, 95 nm or less, 94 nm or less, 93 nm or less, 92 nm or less, or 91 nm or less. According to an embodiment of the present invention, the average primary particle size of the colloidal silica is more than 70 nm and less than 100 nm. The method of measuring the average primary particle size is the method described in EXAMPLES.

According to an embodiment of the present invention, the lower limit of the average secondary particle size of the abrasive grains (particularly, colloidal silica) is 110 nm or more, 120 nm or more, 130 nm or more, 140 nm or more, 150 nm or more, 160 nm or more, 170 nm or more, 180 nm or more, 190 nm or more, 200 nm or more, 210 nm or more, or 215 nm or more.

According to an embodiment of the present invention, the upper limit of the average secondary particle size of the abrasive grains (particularly, colloidal silica) is 350 nm or less, 340 nm or less, 330 nm or less, 320 nm or less, 310 nm or less, 300 nm or less, 290 nm or less, 280 nm or less, 270 nm or less, 260 nm or less, 250 nm or less, 240 nm or less, 230 nm or less, or 225 nm or less. The method of measuring the average secondary particle size is the method described in EXAMPLES.

According to an embodiment of the present invention, the average association degree (average secondary particle size/average primary particle size) of the abrasive grains (particularly, colloidal silica) is 1.6 or more, 1.7 or more, 1.8 or more, 1.9 or more, 2.0 or more, 2.1 or more, 2.2 or more, 2.3 or more, or 2.4 or more.

According to an embodiment of the present invention, the average association degree (average secondary particle size/average primary particle size) of the abrasive grains (particularly, colloidal silica) is 4.6 or less, 4.4 or less, 4.2 or less, 4.0 or less, 3.8 or less, 3.6 or less, 3.4 or less, 3.2 or less, 3.0 or less, 2.9 or less, 2.8 or less, 2.7 or less, 2.6 or less, or 2.5 or less.

According to an embodiment of the present invention, the content ratio of the abrasive grains (particularly, colloidal silica) in the polishing composition is 0.01 mass % or more, 0.05 mass % or more, 0.1 mass % or more, 0.5 mass % or more, 0.6 mass % or more, 0.7 mass % or more, 0.8 mass % or more, 0.9 mass % or more, 1.0 mass % or more, 1.1 mass % or more, 1.2 mass % or more, 1.3 mass % or more, or 1.4 mass % or more.

According to an embodiment of the present invention, the content ratio of the abrasive grains (particularly, colloidal silica) in the polishing composition is 10 mass % or less, 5 mass % or less, 3 mass % or less, or 2 mass % or less.

According to an embodiment of the present invention, the amount of the colloidal silica in the abrasive grains contained in the polishing composition is 90 mass % or more, 95 mass % or more, 98 mass % or more, 99 mass % or more, 99.5 mass % or more, or 99.9 mass % or more (the upper limit is 100 mass %).

According to an embodiment of the present invention, the surface of the abrasive grains (particularly, colloidal silica) contained in the polishing composition is not subjected to a treatment for chemically bonding a treatment agent such as an organic acid (for example, sulfonic acid or carboxylic acid).

### (Alkali Metal Salt)

The polishing composition of an aspect of the present invention contains an alkali metal salt. When the polishing composition does not contain an alkali metal salt, there is a possibility that remaining of an object to be polished, which has to be polished, such as polysilicon, cannot be reduced or recesses are promoted.

According to an embodiment of the present invention, at least one selected from the group consisting of an alkali metal hydroxide and an alkali metal carbonate is contained as the alkali metal salt. According to an embodiment of the present invention, an alkali metal hydroxide is contained as the alkali metal salt. According to an embodiment of the present invention, potassium hydroxide is contained as an alkali metal hydroxide. As the alkali metal salt, from the viewpoint of reducing a remaining metal, an alkali metal hydroxide is more preferable than an alkali metal carbonate. Examples of the alkali metal include potassium, sodium, lithium, and the like, and among these, from the viewpoint of reducing the remaining metal, potassium is particularly preferable.

The alkali metal salt also has a function as a pH adjusting agent for adjusting the pH of the polishing composition. According to an embodiment of the present invention, the content of the pH adjusting agent (particularly, the alkali metal salt) contained in the polishing composition is an amount appropriate for adjusting the pH of the polishing composition to a predetermined pH (particularly, the pH is 9.0 to 11.5).

According to an embodiment of the present invention, the amount of the alkali metal salt (particularly, potassium hydroxide) in the pH adjusting agent contained in the polishing composition is 90 mass % or more, 95 mass % or more, 98 mass % or more, 99 mass % or more, 99.5 mass % or more, or 99.9 mass % or more (the upper limit is 100 mass %). According to an embodiment of the present invention, the amount of potassium hydroxide in the pH adjusting agent contained in the polishing composition is 90 mass % or more, 95 mass % or more, 98 mass % or more, 99 mass % or more, 99.5 mass % or more, or 99.9 mass % or more (the upper limit is 100 mass %). Even if the abrasive grains (particularly, colloidal silica), the polyalkylene glycol, the cellulose derivative, the polymer compound X, and an antiseptic agent that is optionally contained have a function of slightly changing the pH of the polishing composition, they are poor in the ability of changing the pH. Therefore, in the present invention, there is no problem if it (they) is (are) not included in the category of the pH adjusting agent in the present specification.

### [Polyalkylene Glycol]

The polishing composition of an aspect of the present invention contains polyalkylene glycol. When the polishing composition does not contain the polyalkylene glycol, there is a possibility that remaining of the object to be polished, which has to be polished, such as polysilicon, increases. The polyalkylene glycols may be used singly or in combination of two or more kinds thereof. As the polyalkylene glycol, a commercially available product may be used, or a synthesized product may be used.

Kinds of the polyalkylene glycol are not particularly limited, but examples thereof include polyethylene glycol, polypropylene glycol, polytetramethylene glycol, polyethylene glycol-polypropylene glycol random copolymers, polyethylene glycol-polytetramethylene glycol random copolymers, polypropylene glycol-polytetramethylene glycol random copolymers, polyethylene glycol-polypropylene glycol-polytetramethylene glycol random copolymers, polyethylene glycol-polypropylene glycol block copolymers, polypropylene glycol-polyethylene glycol-polypropylene glycol triblock copolymers, polyethylene glycol-polypropylene glycol-polyethylene glycol triblock copolymers, and the like. Among these, from the viewpoint of reducing remaining of the object to be polished, which has to be polished, such as polysilicon, more effectively, polyethylene glycol and polypropylene glycol are preferable, and polyethylene glycol is more preferable.

In an embodiment of the present invention, the weight average molecular weight (Mw) of the polyalkylene glycol is 50 or more, 70 or more, 90 or more, 100 or more, 120 or more, 150 or more, 160 or more, 170 or more, 180 or more, or 190 or more. In an embodiment of the present invention, the weight average molecular weight (Mw) of the polyalkylene glycol is 2,000 or less, 1,500 or less, 1,000 or less, 800 or less, 700 or less, 600 or less, 500 or less, 400 or less, 300 or less, or 250 or less. In an embodiment of the present invention, the weight average molecular weight of the polyalkylene glycol is, for example, 100 or more and 1,000 or less, 100 or more and 500 or less, or 150 or more and 300 or less. When the weight average molecular weight falls within the range, the effect of reducing remaining of the object to be polished, which has to be polished, such as polysilicon, while controlling the selectivity may be more significant.

In the present specification, the weight average molecular weight of the polyalkylene glycol may be measured by gel permeation chromatography (GPC) based on polyethylene glycol as a standard substance. The detailed measurement method is as described in EXAMPLES.

In an embodiment of the present invention, the mass concentration of the polyalkylene glycol in the object to be polished is 1 mass ppm or more, 2 mass ppm or more, 4 mass ppm or more, 6 mass ppm or more, 8 mass ppm or more, 10 mass ppm or more, more than 10 mass ppm, 15 mass ppm or more, 20 mass ppm or more, 25 mass ppm or more, 30 mass ppm or more, 35 mass ppm or more, 40 mass ppm or more, more than 40 mass ppm, 60 mass ppm or more, or 80 mass ppm or more. In an embodiment of the present invention, the mass concentration of the polyalkylene glycol in the object to be polished is 1,000 mass ppm or less, 800 mass ppm or less, 600 mass ppm or less, 400 mass ppm or less, 200 mass ppm or less, 150 mass ppm or less, 100 mass ppm or less, less than 100 mass ppm, 80 mass ppm or less, 60 mass ppm or less, 50 mass ppm or less, 40 mass ppm or less, 30 mass ppm or less, 20 mass ppm or less, or 15 mass ppm or less. In an embodiment of the present invention, the mass concentration of the polyalkylene glycol in the object to be polished is, for example, 1 mass ppm or more and 1,000 mass ppm or less, 4 mass ppm or more and 600 mass ppm or less, 8 mass ppm or more and 400 mass ppm or less, or 10 mass ppm or more and 200 mass ppm or less. When the mass concentration falls within the range, the effect of reducing remaining of the object to be polished, which has to be polished, such as polysilicon, may be more significant.

### [Cellulose Derivative and Polymer Compound X]

The polishing composition of an aspect of the present invention contains at least one selected from the group consisting of a cellulose derivative and a polymer compound X. When the polishing composition does not contain at least one selected from the group consisting of the cellulose derivative and the polymer compound X, there is a possibility that recesses are promoted. The cellulose derivatives and the polymer compounds X may be each used singly or in combination of two or more kinds thereof. As the cellulose derivative and the polymer compound X, a commercially available product may be used, or a synthesized product may be used.

### (Cellulose Derivative)

In an embodiment of the present invention, “cellulose derivative” refers to a derivative in which a part of the hydroxy group of the cellulose is substituted by a different substituent. The cellulose derivatives may be used singly or in combination of two or more kinds thereof Examples of the cellulose derivative include cellulose derivatives such as hydroxyethyl cellulose (HEC), hydroxypropyl cellulose, hydroxyethyl methyl cellulose, hydroxypropyl methyl cellulose, methyl cellulose, ethyl cellulose, ethyl hydroxyethyl cellulose, and carboxymethyl cellulose; pullulan; and the like.

### (Polymer Compound X)

The polymer compound X contains a repeating unit represented by the following formula (1):

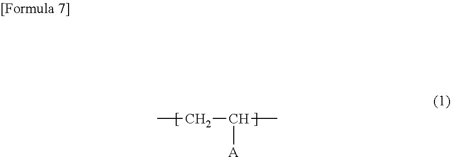

wherein A is a group selected from at least one kind of the followings:

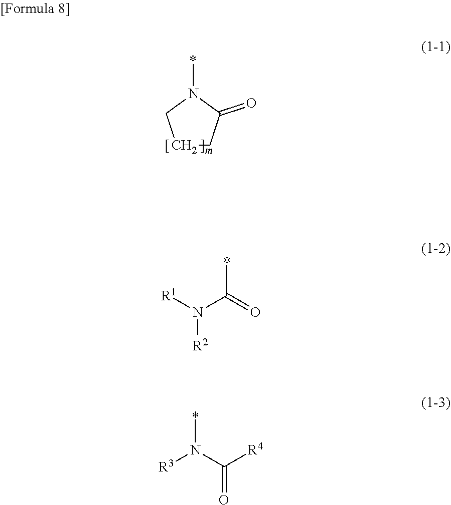

wherein m is an integer of 1 to 5; R¹ to R⁴ are each independently selected from the group consisting of a hydrogen atom and an alkyl group having 1 to 4 carbon atoms, wherein R¹ and R² may form a ring and, in a case where the ring is formed, at least one oxygen atom may be contained in the ring, and wherein R³ and R⁴ may form a ring and, in a case where the ring is formed, at least one oxygen atom may be contained in the ring; and at least one oxygen atom may be contained in a ring in the formula 1-1. Wherein “*” represents a bonding site. The number of oxygen atoms contained in the ring is, for example, 1 or 2. Also, the polymer compound X optionally further contains a repeating unit represented by the following formula (2):

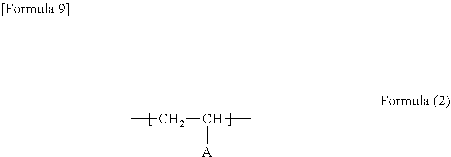

wherein A is a hydroxy group.

In an embodiment of the present invention, R¹ and R² are each independently selected from the group consisting of a hydrogen atom and an alkyl group having 1 to 4 carbon atoms. In an embodiment of the present invention, R³ and R⁴ are each independently selected from the group consisting of a hydrogen atom and an alkyl group having 1 to 4 carbon atoms.

In an embodiment of the present invention, m is 1, 2, 3, or 4.

In an embodiment of the present invention, the number of carbon atoms of the alkyl group in each R¹ to R⁴ is 1 to 3 or 1 or 2. In an embodiment of the present invention, the alkyl group having 1 to 4 carbon atoms is, for example, a methyl group, an ethyl group, a propyl group, an i-propyl group, a butyl group, or a t-butyl group.

In an embodiment of the present invention, at least one of R¹ and R² is a hydrogen atom.

In an embodiment of the present invention, one of R³ and R⁴ is a hydrogen atom, and the other one thereof is an alkyl group having 1 to 4 carbon atoms.

In a case where the polymer compound X in an embodiment of the present invention contains a repeating unit in which A is represented by at least one kind of the formulas (1-1), (1-2), and (1-3) in the formula (1), the repeating unit is present by 90 mol % or more or 95 mol % or more in the polymer compound X (the upper limit is 100 mol %). In a case where the polymer compound X contained in an embodiment of the present invention contains a repeating unit in which A is the formula (1-1) in the formula (1), the repeating unit is present by 90 mol % or more or 95 mol % or more in the polymer compound X (the upper limit is 100 mol %).

In a case where the polymer compound X in an embodiment of the present invention contains a repeating unit in which A is at least one kind of the formulas (1-1), (1-2), and (1-3) in the formula (1) and a repeating unit in which A is a hydroxy group in the formula (2), the total of these repeating units is 90 mol % or more or 95 mol % or more in the polymer compound X (the upper limit is 100 mol %). In an embodiment of the present invention, in a case where the polymer compound X contains a repeating unit in which A is the formula (1-1) in the formula (1) and a repeating unit in which A is a hydroxy group in the formula (2), the total of these repeating units is 90 mol % or more or 95 mol % or more in the polymer compound X (the upper limit is 100 mol %).

In an embodiment of the present invention, specific examples of the repeating unit (N-vinyl lactam type repeating unit) in which A is the formula (1-1) include N-vinylpyrrolidone (VP), N-vinylpiperidone, N-vinylcaprolactam (VC), and the like. In an embodiment of the present invention, preferable examples of the polymer containing a N-vinyl lactam type repeating unit include vinylpyrrolidone polymers.

Here, the vinylpyrrolidone polymers mean homopolymers of VP or copolymers of VP (for example, a copolymer in which the copolymerization ratio of VP is more than 20 mol %). Here, examples of the copolymer of VP include a copolymer (PVA-PVP) of VP and VA (vinyl alcohol). The proportion of the molar amount of VP units with respect to the molar amount of the total repeating units is usually 20 mol % or more in the vinylpyrrolidone polymer, but the proportion may be 25 mol % or more, 30 mol % or more, 50 mol % or more, 80 mol % or more, 90 mol % or more, or 95 mol % or more (the upper limit is 100 mol %).

In an embodiment of the present invention, specific examples of the repeating unit in which A is the formula (1-2) (repeating unit derived from an a, β-unsaturated amide type monomer) include acryloylmorpholine, acrylamide, dimethylacrylamide, N-isopropylacrylamide, and the like. An example in which R³ and R⁴ form a ring and at least one oxygen atom is contained in the ring is acryloylmorpholine. In an embodiment of the present invention, preferable examples of the polymer derived from the α,β-unsaturated amide type monomer include acrylamide polymers. Here, the acrylamide polymers mean homopolymers of acrylamide or copolymers of acrylamide (for example, a copolymer in which the copolymerization ratio of acrylamide is more than 50 mol %). The proportion of the molar amount of acrylamide units with respect to the molar amount of the total repeating units is usually 50 mol % or more in the acrylamide polymer, and the appropriate proportion is 80 mol % or more (for example, 90 mol % or more and typically 95 mol % or more) (the upper limit is 100 mol %).

In an embodiment of the present invention, specific examples of the repeating unit in which A is the formula (1-3) (N-vinyl chain amide type repeating unit) include N-vinylacetamide, N-vinylpropionic acid amide, N-vinylbutyric acid amide, and the like. In an embodiment of the present invention, preferable examples of the polymer containing a N-vinyl chain amide type repeating unit include vinylacetamide polymers. Here, the vinylacetamide polymers mean homopolymers of vinylacetamide or copolymers of vinylacetamide (for example, a copolymer in which the copolymerization ratio of vinylacetamide is more than 50 mol %). In the vinylacetamide polymers, the proportion of the molar amount of vinylacetamide units with respect to the molar amount of the total repeating units is usually 50 mol % or more, and the appropriate proportion is 80 mol % or more (for example, 90 mol % or more, and typically 95 mol % or more) (the upper limit is 100 mol %).

In an embodiment of the present invention, the polymer compound X may be polyvinylpyrrolidone, polyacrylamide, poly-N-vinylacetamide, or a copolymer (PVP-PVA) of vinylpyrrolidone and vinyl alcohol. Among these, from the viewpoint of allowing for suppressing of recesses while reducing remaining of the object to be polished, which has to be polished, such as polysilicon, polyvinylpyrrolidone or a copolymer (PVP-PVA) of vinylpyrrolidone and vinyl alcohol is preferable, and polyvinylpyrrolidone is more preferable.

In an embodiment of the present invention, the weight average molecular weight of each of the cellulose derivative and the polymer compound X is independently 1,000 or more, 2,000 or more, 4,000 or more, 6,000 or more, 8,000 or more, more than 8,000, 10,000 or more, 20,000 or more, 40,000 or more, 43,000 or more, 47,000 or more, 60,000 or more, 90,000 or more, 120,000 or more, 160,000 or more, 200,000 or more, 500,000 or more, or 1,000,000 or more. In an embodiment of the present invention, the weight average molecular weight of each of the cellulose derivative and the polymer compound X is independently 2,000,000 or less, 1,500,000 or less, 1,000,000 or less, 500,000 or less, 400,000 or less, 300,000 or less, less than 250,000, 250,000 or less, 100,000 or less, 90,000 or less, 80,000 or less, 70,000 or less, 60,000 or less, 50,000 or less, 40,000 or less, 30,000 or less, 20,000 or less, or 10,000 or less. In an embodiment of the present invention, the weight average molecular weight of each of the cellulose derivative and the polymer compound X is independently 1,000 or more and 2,000,000 or less. In an embodiment of the present invention, the weight average molecular weight of the cellulose derivative may be 500,000 or more and 2,000,000 or less, or 1,000,000 or more and 1,500,000 or less. In an embodiment of the present invention, the weight average molecular weight of the polymer compound X may be 1,000 or more and 250,000 or less, 10,000 or more and 100,000 or less, or 20,000 or more and 90,000 or less. When the weight average molecular weight falls within the range, the effect of reducing remaining of the object to be polished, which has to be polished, such as polysilicon, and suppressing recesses may be more significant.

In an embodiment of the present invention, the mass concentration of each of the cellulose derivative and the polymer compound X in the object to be polished is independently 1 mass ppm or more, 2 mass ppm or more, 4 mass ppm or more, 6 mass ppm or more, 8 mass ppm or more, 10 mass ppm or more, more than 10 mass ppm, 15 mass ppm or more, 20 mass ppm or more, 15 mass ppm or more, 20 mass ppm or more, 25 mass ppm or more, 30 mass ppm or more, 35 mass ppm or more, or 40 mass ppm or more. In an embodiment of the present invention, the mass concentration of each of the cellulose derivative and the polymer compound X in the object to be polished is independently 1,000 mass ppm or less, 800 mass ppm or less, 600 mass ppm or less, 400 mass ppm or less, 200 mass ppm or less, 100 mass ppm or less, less than 100 mass ppm, 80 mass ppm or less, 60 mass ppm or less, 50 mass ppm or less, or 40 mass ppm or less. In an embodiment of the present invention, the mass concentration of each of the cellulose derivative and the polymer compound X in the object to be polished is independently more than 10 mass ppm and less than 100 mass ppm. When the mass concentration falls within the range, the effect of reducing remaining of the object to be polished, which has to be polished, such as polysilicon, and suppressing recesses, may be significant. Here, in a case where the object to be polished contains two or more kinds of the polymer compounds X, the mass concentration of the polymer compound X in the object to be polished means the total of the mass concentrations of the two or more kinds of the polymer compounds X in the object to be polished. In a case where the object to be polished contains one kind of the polymer compound X, the mass concentration of the polymer compound X in the object to be polished means the mass concentration of the one kind of the polymer compound X in the object to be polished.

[pH]

The pH of the polishing composition of an aspect of the present invention is 9.0 to 11.5. When the pH of the polishing composition is less than 9.0 or more than 11.5, there is a possibility that the effect of reducing remaining of the object to be polished, which has to be polished, such as polysilicon, and suppressing recesses cannot be obtained.

According to an embodiment of the present invention, the pH of the polishing composition is 9.1 or more, 9.2 or more, 9.3 or more, 9.4 or more, 9.5 or more, more than 9.5, 9.6 or more, 9.7 or more, 9.8 or more, 9.9 or more, or 10.5 or more. According to an embodiment of the present invention, the pH of the polishing composition is 11.5 or less, 11.4 or less, 11.3 or less, 11.2 or less, less than 11.2, 11.1 or less, 11 or less, less than 11, 10.9 or less, 10.8 or less, 10.7 or less, 10.6 or less, 10.5 or less, 10.4 or less, 10.3 or less, 10.2 or less, 10.1 or less, or 9.8 or less.

According to an embodiment of the present invention, the pH of the polishing composition is more than 10.0 and less than 11.2. When the pH falls within the range, the effect of reducing remaining of the object to be polished, which has to be polished, such as polysilicon, and suppressing recesses may be more significant.

According to an embodiment of the present invention, the pH of the polishing composition is not 9.1, 9.2, 9.3, 9.4, 9.6, 9.7, 9.8, 9.9, 10.1, 10.2, 10.3, 10.4, 10.5, 10.6, 10.7, 10.9, 11.1, 11.3, 11.4, or 11.5. The method of measuring the pH of the polishing composition is the method described in EXAMPLES.

### [Object to be Polished]

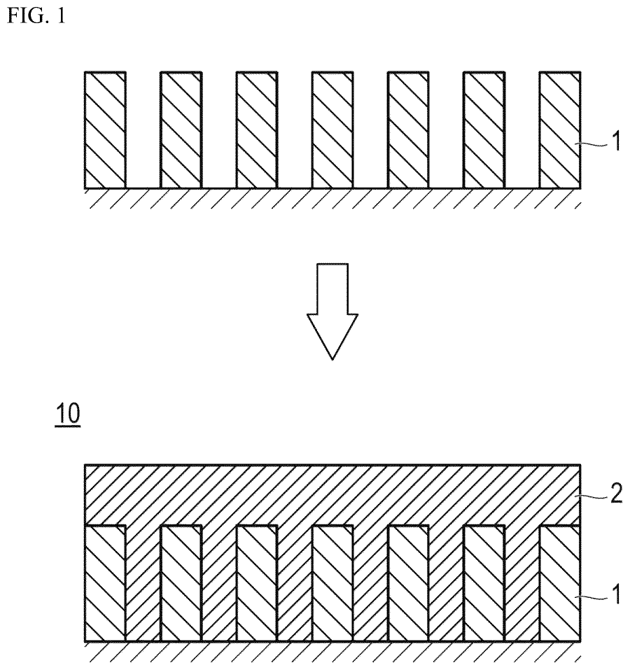

According to an embodiment of the present invention, the polishing composition is used in a step of polishing a second layer to expose a first layer in an object to be polished including a first layer provided with a recess portion and a second layer formed to fill the inside of the recess portion. FIG. 1 is a schematic cross-sectional view of an object to be polished (before polishing). As illustrated in the upper view of FIG. 1, a first layer 1 (a film having an oxygen-silicon bond or a nitrogen-silicon bond) is formed on an arbitrary film (for example, a Si substrate) so as to provide a recess portion. As illustrated in the lower view of FIG. 1, a second layer 2 (a film having a silicon-silicon bond) is formed so as to fill the inside of the recess portion, thereby forming an object to be polished 10 including the first layer and the second layer.

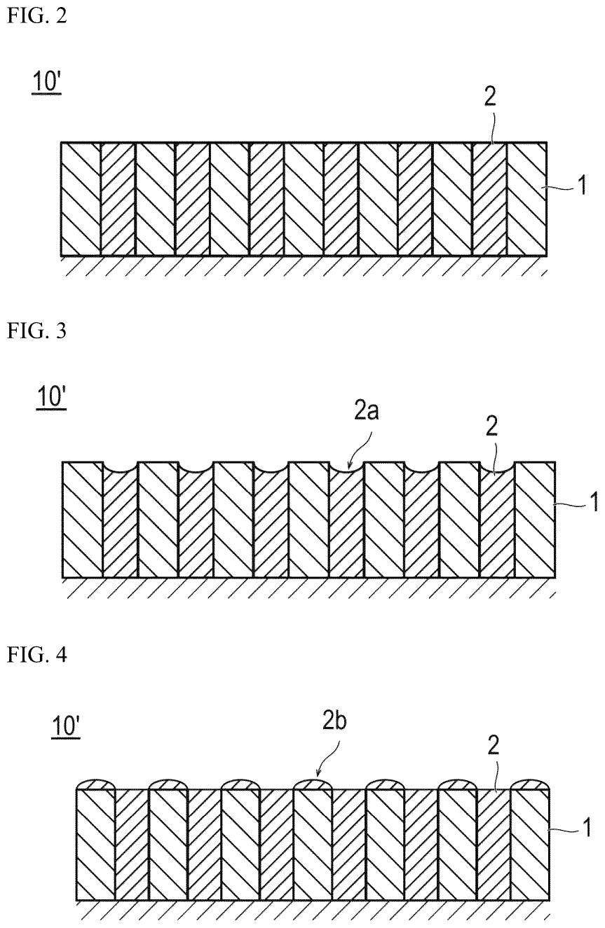

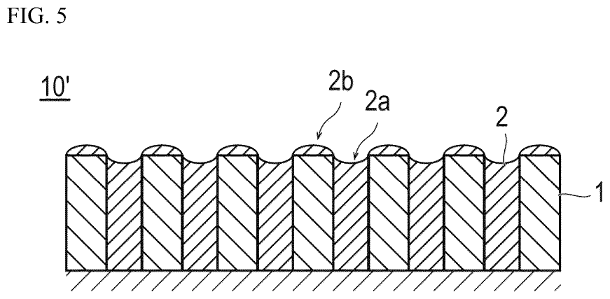

According to an embodiment of the present invention, when the polishing composition of the present invention is applied, a polished object 10′ may have an ideal polished surface in which remaining of the object to be polished (a film having a silicon-silicon bond), which has to be polished, is reduced (or completely removed) and/or recesses are suppressed (or no recess has occurred) as illustrated in FIG. 2. In addition, by applying the polishing composition of the present invention, the number of metal atoms that may remain after polishing may also be reduced. According to an embodiment of the present invention, the number of metal atoms remaining per 1 cm² of the polished object (unit: x 1010/cm²) is less than 40, less than 38, less than 35, less than 30, less than 25, less than 24, less than 20, less than 19, or less than 17. According to an embodiment of the present invention, the number of metal atoms remaining per 1 cm² of the polished object (unit: ×10¹⁰/cm²) is, for example, 0, 0.01 or more, 0.5 or more, 1 or more, 5 or more, or 10 or more. FIG. 3 is a schematic cross-sectional view in which a recess 2a has occurred. FIG. 4 is a schematic cross-sectional view in which remaining 2b of an object to be polished (a film having a silicon-silicon bond), which has to be polished, has occurred. FIG. 5 is a schematic cross-sectional view in which the recess 2a and the remaining 2b of the object to be polished (a film having a silicon-silicon bond), which has to be polished, have occurred simultaneously.

In an embodiment of the present invention, examples of the object to be polished having an oxygen-silicon bond include a TEOS type silicon oxide (hereinafter, also simply referred to as “TEOS”) produced using tetraethyl orthosilicate as a precursor, HDP (High Density Plasma), USG (Undoped Silicate Glass), PSG (Phosphorus Silicate Glass), BPSG (Boron-Phospho Silicate Glass), RTO (Rapid Thermal Oxidation), and the like. A TEOS film can be formed by plasma CVD.

In an embodiment of the present invention, examples of the object to be polished having a nitrogen-silicon bond include a silicon nitride film, SiCN (silicon carbonitride), and the like. As a material of the stopper film, the first layer preferably contains an object to be polished having a nitrogen-silicon bond. In an embodiment of the present invention, examples of the object to be polished having a silicon-silicon bond include polysilicon, amorphous silicon, monocrystalline silicon, n-type doped monocrystalline silicon, p-type doped monocrystalline silicon, Si-based alloys such as SiGe, and the like. Among them, the second layer is preferably polycrystalline silicon such as polysilicon.

### [Polishing Removal Rate]

According to an embodiment of the present invention, the polishing composition has the physical property of the polishing removal rate of the second layer of 1500 Å/min or more, 1600 Å/min or more, 1700 Å/min or more, 1800 Å/min or more, or 1900 Å/min or more. According to an embodiment of the present invention, the polishing composition has the physical property of the polishing removal rate of the second layer of 3500 Å/min or less, 3000 Å/min or less, 2500 Å/min or less, or 2000 Å/min or less.

According to an embodiment of the present invention, in a case where the first layer has an oxygen-silicon bond, the polishing composition has the physical property of the polishing removal rate of the first layer of 45 Å/min or more, 50 Å/min or more, 60 Å/min or more, 70 Å/min or more, 80 Å/min or more, or 85 Å/min or more. According to an embodiment of the present invention, in a case where the first layer has an oxygen-silicon bond, the polishing composition has the physical property of the polishing removal rate of the first layer of 180 Å/min or less, 160 Å/min or less, 140 Å/min or less, 120 Å/min or less, 100 Å/min or less, or 95 Å/min or less.

According to an embodiment of the present invention, in a case where the first layer has a nitrogen-silicon bond, the polishing composition has the physical property of the polishing removal rate of the first layer of 10 Å/min or more, 12 Å/min or more, 14 Å/min or more, 16 Å/min or more, 18 Å/min or more, 20 Å/min or more, 22 Å/min or more, 24 Å/min or more, or 26 Å/min or more. According to an embodiment of the present invention, in a case where the first layer has a nitrogen-silicon bond, the polishing composition has the physical property of the polishing removal rate of the first layer of 50 Å/min or less, 40 Å/min or less, 30 Å/min or less, 28 Å/min or less, or 26 Å/min or less.

### [Selectivity]

According to an embodiment of the present invention, in a case where the first layer has an oxygen-silicon bond, the polishing composition has the physical property of the polishing removal rate of the second layer with respect to the polishing removal rate of the first layer (selectivity) of 17 to 40 or 20 to 40.

According to an embodiment of the present invention, in a case where the first layer has a nitrogen-silicon bond, the polishing composition has the physical property of the polishing removal rate of the second layer with respect to the polishing removal rate of the first layer (selectivity) of more than 40 and 100 or less, 45 to 95, 50 to 90, 55 to 85, or 60 to 80.

According to an embodiment of the present invention, in a case where the first layer has an oxygen-silicon bond, the polishing composition has the physical property of the selectivity of 17 or more, 18 or more, 19 or more, 20 or more, 21 or more, 22 or more, 23 or more, 24 or more, 25 or more, 26 or more, 27 or more, 28 or more, 29 or more, 30 or more, 31 or more, 32 or more, 33 or more, 34 or more, or 35 or more. According to an embodiment of the present invention, in a case where the first layer has an oxygen-silicon bond, the polishing composition has the physical property of the selectivity of 39 or less, 37 or less, 35 or less, 33 or less, 31 or less, or 29 or less.

According to an embodiment of the present invention, in a case where the first layer has a nitrogen-silicon bond, the polishing composition has the physical property of the selectivity of more than 40, 45 or more, 50 or more, 55 or more, 60 or more, 65 or more, or 70 or more. According to an embodiment of the present invention, in a case where the first layer has a nitrogen-silicon bond, the polishing composition has the physical property of the selectivity of 95 or less, 90 or less, 85 or less, 80 or less, 75 or less, or 70 or less.

### [Transmittance]

According to an embodiment of the present invention, a transmittance when light whose wavelength is 450 nm is transmitted through the polishing composition is more than 0.1% and less than 1% in a case where a concentration of the abrasive grains (particularly, colloidal silica) contained in the polishing composition is 1.5 mass %. According to the polishing composition of the embodiment, the transmittance contributes to suppressing remaining of polysilicon. Examples of the method of adjusting the transmittance to the above range include a method of adjusting the particle size of the colloidal silica and a method of adjusting an electrical conductivity.

According to an embodiment of the present invention, the transmittance is 0.13% or more, 0.15% or more, 0.2% or more, or 0.5% or more. According to an embodiment of the present invention, the transmittance is 0.9% or less, 0.7% or less, 0.5% or less, or 0.3% or less.

When the abrasive grain concentration of the polishing composition is not 1.5 mass %, the adjustment of the abrasive grain concentration to 1.5 mass % can be performed as follows. That is, when the abrasive grain concentration of the polishing composition is more than 1.5 mass %, an appropriate amount of water can be added so that the abrasive grain concentration becomes 1.5 mass %. When the abrasive grain concentration of the polishing composition is less than 1.5 mass %, the polishing composition may be stored in an environment of 25 to 40° C. until the abrasive grain concentration becomes 1.5 mass %, or a treatment such as ultrafiltration may be performed.

### [Water]

The polishing composition of an aspect of the present invention contains water as an aqueous carrier. According to an embodiment of the present invention, the aqueous carrier is not limited that the aqueous carrier necessarily includes alcohols such as methanol, ethanol, and ethylene glycol; ketones such as acetone; and the like, and the amount of water in the aqueous carrier is 90 mass % or more, 95 mass % or more, 98 mass % or more, 99 mass % or more, 99.5 mass % or more, or 99.9 mass % or more (the upper limit is 100 mass %).

### [Antiseptic Agent]

According to an embodiment of the present invention, the polishing composition contains an antiseptic agent. The polishing composition may be an aqueous liquid, which makes it easy for microorganisms (bacteria and mold) to propagate and, therefore, stability may be impaired when the composition is stored for a long period of time or when the composition is used. Therefore, an antiseptic agent is added, and the polishing composition may contain an antiseptic agent having a function of suppressing increase of microorganisms (bacteria and mold). Examples of the antiseptic agent include isothiazolinone antiseptic agents such as 2-methyl-4-isothiazolin-3-one, 5-chloro-2-methyl-4-isothiazolin-3-one, and 1,2-benzoisothiazol-3 (2H)-one (BIT); paraoxybenzoic acid ester antiseptic agents such as methyl paraoxybenzoate (methyl parahydroxybenzoate) and ethyl paraoxybenzoate (ethyl parahydroxybenzoate); phenoxyethanol; and the like. These antiseptic agents may be used singly or in combination of two or more kinds thereof.

According to an embodiment of the present invention, the antiseptic agent may be contained in the polishing composition in an amount of 0.001 to 1 mass %, 0.005 to 0.5 mass %, or 0.01 to 0.1 mass %.

According to an embodiment of the present invention, a polishing composition consisting essentially of colloidal silica having 6/nm² or more and 22/nm² or less silanol groups; an alkali metal salt; polyalkylene glycol; at least one selected from the group consisting of a cellulose derivative and a polymer compound X; an antiseptic agent; and water,
wherein the polymer compound X contains a repeating unit represented by the following formula (1):

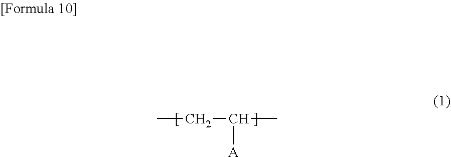

wherein A is a group selected from at least one kind of the followings:

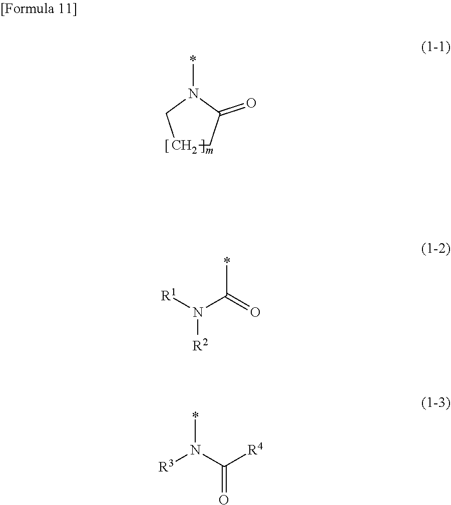

wherein m is an integer of 1 to 5; R¹ to R⁴ are each independently selected from the group consisting of a hydrogen atom and an alkyl group having 1 to 4 carbon atoms, wherein R¹ and R² may form a ring and, in a case where the ring is formed, at least one oxygen atom may be contained in the ring, and wherein R³ and R⁴ may form a ring and, in a case where the ring is formed, at least one oxygen atom may be contained in the ring; and at least one oxygen atom may be contained in a ring in the formula 1-1, wherein the polymer compound X optionally further contains a repeating unit represented by the following formula (2):

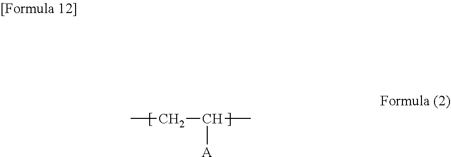

wherein A is a hydroxy group, and
wherein a pH of the polishing composition is 9.0 to 11.5 is provided. The above description may be applied to descriptions on the colloidal silica, the alkali metal salt, the polyalkylene glycol, the at least one selected from the group consisting of the cellulose derivative and the polymer compound X, the water, the pH, and the antiseptic agent. Description on the phrase “consisting essentially of” will be described later.

### [Other Components]

According to an embodiment of the present invention, the polishing composition is substantially free of at least any of a surfactant, an oxidizing agent, and a compound having a nitrogen atom (except for the cellulose derivative and the polymer compound X). Here, “substantially free of” means that the content of the component is 0.1 mass % or less, 0.01 mass % or less, 0.001 mass % or less, or less than 0.0001 mass % in the polishing composition, unless otherwise specified.

The surfactant is a substance having a hydrophilic group and a hydrophobic group. Examples of the surfactant include alkyl ether type surfactants such as polyoxyethylene lauryl ether and polyoxyethylene oleyl ether; alkylphenyl ether type surfactants such as polyoxyethylene octylphenyl ether; alkyl ester type surfactants such as polyoxyethylene laurate; alkylamine type surfactants such as polyoxyethylene laurylamino ether; alkylamide type surfactants such as polyoxyethylene lauric acid amide; polypropylene glycol ether type surfactants such as polyoxyethylene polyoxypropylene ether; alkanolamide type surfactants such as oleic acid diethanolamide; allyl phenyl ether type surfactants such as polyoxyalkylene allyl phenyl ether; and the like. Examples thereof include nonionic surfactants such as propylene glycol, diethylene glycol, monoethanolamine, alcohol ethoxylates, alkylphenol ethoxylates, tertiary acetylene glycol, and alkanolamides; carboxylic acid type anionic surfactants such as sodium myristate, sodium palmitate, sodium stearate, sodium laurate, and potassium laurate; sulfate ester type anionic surfactants such as sodium octyl sulfate; phosphate ester type anionic surfactants such as lauryl phosphate and sodium lauryl phosphate; sulfonic acid type anionic surfactants such as sodium dioctyl sulfosuccinate and sodium dodecyl benzenesulfonate; cationic surfactants such as amines such as laurylamine hydrochloride; and amphoteric surfactants such as lecithin, alkylamine oxide, alkyl betaines such as N-alkyl-N,N-dimethylammonium betaine, and sulfobetaines. According to an embodiment of the present invention, the polishing composition is substantially free of at least one kind selected from the group consisting of these. The term “one kind” described in this paragraph may mean one kind in the meaning of “genus” of “surfactants”, or one kind in the meaning of “species” such as “polyoxyethylene lauryl ether”. Description on the phrase “at least one kind” is also applied to the description below.

The oxidizing agent may be a substance having an oxidation-reduction potential higher than an oxidation-reduction potential of a substrate material (particularly, polysilicon) at a pH at which polishing is performed. The pH at which polishing is performed is usually the same as the pH of the polishing composition. As the oxidation-reduction potential of the substrate material, a value, which is obtained by dispersing a powder of the material (particularly, polysilicon) in water to form a slurry, adjusting the slurry to have the same pH as that of the polishing composition, and then measuring the oxidation-reduction potential (oxidation-reduction potential with respect to a standard hydrogen electrode at a liquid temperature of 25° C.) of the slurry using a commercially available oxidation-reduction potential meter, can be adopted. Examples of the oxidizing agent include hydrogen peroxide, a metal oxide, a peroxide, a nitrate, an iodate, a periodate, a hypochlorite, a chlorite, a chlorate, a perchlorate, a persulfate, a dichromate, a permanganate, an organic oxidizing agent, ozone water, a silver (II) salt, an iron (III) salt, and the like. According to an embodiment of the present invention, the polishing composition is substantially free of at least one kind selected from the group consisting of these.

Examples of the compound having a nitrogen atom include hydroxides of, for example, tetramethylammonium, tetraethylammonium, and tetrabutylammonium; salts such as chlorides, carbonates, sulfates, and phosphates; and the like. Specific examples thereof include quaternary ammonium compounds such as tetraalkylammonium hydroxides such as tetramethylammonium hydroxide, tetraethylammonium hydroxide, and tetrabutylammonium hydroxide, tetramethylammonium carbonate, and tetraalkylammonium hydroxide salts such as tetramethylammonium chloride; amines such as methylamine, dimethylamine, trimethylamine, ethylamine, diethylamine, triethylamine, ethylenediamine, monoethanolamine, N-(β-aminoethyl) ethanolamine, hexamethylenediamine, diethylenetriamine, triethylenetetramine, anhydrous piperazine, piperazine hexahydrate, 1-(2-aminoethyl) piperazine, N-methylpiperazine, and guanidine; and ammonia. According to an embodiment of the present invention, the polishing composition is substantially free of at least one kind selected from the group consisting of these. According to an embodiment of the present invention, the content of tetraalkylammonium salt is less than 0.05 mass % in the polishing composition.

According to an embodiment of the present invention, the polishing composition is substantially free of abrasive grains other than colloidal silica.

According to an embodiment of the present invention, the polishing composition is substantially free of silica having an acidic group derived from an organic acid (for example, a sulfo group, a carboxyl group, a phosphate group, and the like) immobilized on the surface thereof.

According to an embodiment of the present invention, the polishing composition is substantially free of silica having an amino group immobilized on the surface thereof.

According to an embodiment of the present invention, the polishing composition is substantially free of an organic acid.

According to an embodiment of the present invention, the polishing composition does not contain any of R¹R²R³R⁴N⁺X⁻, R¹R²R³R⁴P+X⁻, R¹R²R³S+X⁻, imidazolium salts, and pyridinium salts, wherein R¹, R², R³, and R⁴ are each independently a C₁ to C₆ alkyl, a C₇ to C₁₂ arylalkyl, or a C₆ to C₁₀ aryl; and X⁻ is an anion. The reason thereof is that, when a cationic agent having such a hydrophobic part is adsorbed by the surface of the colloidal silica, the surface of the colloidal silica becomes hydrophobic, whereby the colloidal silica is less likely to be separated from the object to be polished (particularly, polysilicon) having high water repellency, whereby the colloidal silica is likely to remain as residue.

According to an embodiment of the present invention, the polishing composition does not contain either carrageenan or xanthan gum.

According to an embodiment of the present invention, the polishing composition is substantially free of a phosphate ester. In the present specification, the phrase “substantially free of a phosphate ester” means that the polishing composition does not contain a phosphate ester at all (detection limit or less), and the phosphate ester may be contained in an amount of less than 0.001 mass % in the polishing composition.

In an embodiment of the present invention, a polishing composition consisting essentially of colloidal silica having 6/nm² or more and 22/nm² or less silanol groups; an alkali metal salt; polyalkylene glycol; at least one selected from the group consisting of a cellulose derivative and a polymer compound X; and water,
wherein the polymer compound X contains a repeating unit represented by the following formula (1):

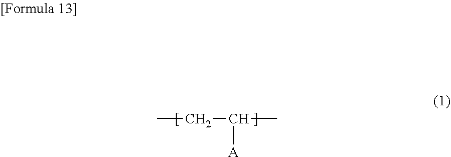

wherein A is a group selected from at least one kind of the followings:

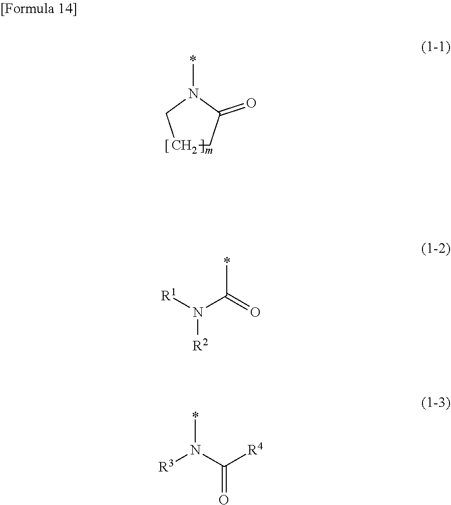

wherein m is an integer of 1 to 5; R¹ to R⁴ are each independently selected from the group consisting of a hydrogen atom and an alkyl group having 1 to 4 carbon atoms, wherein R¹ and R² may form a ring and, in a case where the ring is formed, at least one oxygen atom may be contained in the ring, and wherein R³ and R⁴ may form a ring and, in a case where the ring is formed, at least one oxygen atom may be contained in the ring; and at least one oxygen atom may be contained in a ring in the formula 1-1,
wherein the polymer compound X optionally further contains a repeating unit represented by the following formula (2):

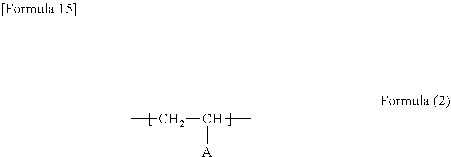

wherein A is a hydroxy group, and
wherein a pH of the polishing composition is 9.0 to 11.5 is provided. The above description may be applied to descriptions on the colloidal silica, the alkali metal salt, the polyalkylene glycol, the at least one selected from the group consisting of the cellulose derivative and the polymer compound X, the water, and the pH. “Consisting essentially of” means that, in a case where the polishing composition contains a component other than colloidal silica, an alkali metal salt (particularly, potassium hydroxide), polyalkylene glycol, at least one selected from the group consisting of a cellulose derivative and a polymer compound X, water, and an antiseptic agent that is optionally contained, the ratio thereof (the ratio of the total thereof) is 0.1 mass % or less, 0.01 mass % or less, 0.001 mass % or less, or less than 0.0001 mass % in the polishing composition.

In an embodiment of the present invention, the polishing composition may be a one-pack type or a multi-pack type including a two-pack type. The polishing composition of an aspect of the present invention may be, for example, diluted (typically, diluted with water) and used as a polishing liquid, or may be used as it is as a polishing liquid. That is, the concept of the polishing composition in the technique according to the present invention includes both a polishing composition (working slurry) that is supplied to an object to be polished and used for polishing the object to be polished and a concentrated solution (a stock solution of a working slurry) that is used for polishing after dilution. The concentration rate of the concentrated solution can be, for example, about 2 times to about 100 times on a volume basis.

### <Method for Producing Polishing Composition>

In an embodiment of the present invention, a method for producing the polishing composition includes adjusting the pH to 9.0 to 11.5 by allowing the polishing composition to contain colloidal silica, an alkali metal salt (particularly, potassium hydroxide), polyalkylene glycol (particularly, PEG), at least one selected from the group consisting of a cellulose derivative and a polymer compound X (particularly, PVP), water, and an antiseptic agent that is optionally contained. The above description may be applied to descriptions on the colloidal silica, the alkali metal salt (particularly, potassium hydroxide), the at least one selected from the group consisting of the cellulose derivative and the polymer compound X (particularly, PVP), the water, the pH, and the antiseptic agent. The temperature at which respective components are mixed is not particularly limited, and is preferably 10° C. or higher and 40° C. or lower, and heating may be performed in order to increase the rate of dissolution. The mixing time is also not particularly limited as long as the mixture can be uniformly mixed.

### <Polishing Method of Object to be Polished>

In an embodiment of the present invention, as illustrated in FIG. 1, in the object to be polished 10 including a first layer 1 provided with a recess portion (a layer having an oxygen-silicon bond or a nitrogen-silicon bond) and a second layer 2 formed to fill the inside of the recess portion (a layer having a silicon-silicon bond), a polishing method of an object to be polished includes a step of polishing the second layer 2 to expose the first layer 1. In an embodiment of the present invention, a step of further polishing the first layer after the first layer is exposed is included. By further including such a step, a technical effect of completely removing remaining of an object to be polished, which has to be polished, such as polysilicon, is achieved.

In an embodiment of the present invention, as illustrated in FIG. 1, the first layer 1 (a layer having an oxygen-silicon bond or a layer having a nitrogen-silicon bond) is formed on an arbitrary film (for example, a Si substrate) so as to provide a recess portion. The second layer 2 (a film having a silicon-silicon bond) is formed so as to fill the inside of the recess portion, and the second layer 2 is laminated in an excessive amount so as to protrude from the recess portion of the first layer 1, thereby forming the object to be polished 10 including the first layer 1 and the second layer 2. Such an object to be polished 10 is polished by a polishing apparatus capable of supplying the polishing composition of the present invention.

In an embodiment of the present invention, as a polishing apparatus, it is possible to use a general polishing apparatus in which a holder for holding a substrate or the like having an object to be polished and a motor or the like capable of changing the number of revolutions are attached and which has a polishing table to which a polishing pad (polishing cloth) can be attached.

In an embodiment of the present invention, as the polishing pad, a general nonwoven fabric, polyurethane, a porous fluororesin, and the like can be used without particular limitation. The polishing pad is preferably grooved such that a polishing liquid is accumulated.

In an embodiment of the present invention, as for the polishing conditions, for example, the rotation speeds of the polishing table and the carrier are each independently preferably 10 to 500 rpm or less. The pressure (polishing pressure) applied to the substrate having an object to be polished is preferably 0.5 to 10 psi. The method of supplying the polishing composition to the polishing pad is not particularly limited, and for example, a method of continuously supplying the polishing composition by a pump or the like is adopted. This supply amount is not limited, but it is preferable that the surface of the polishing pad is covered with the polishing composition of the present invention at all times.

In an embodiment of the present invention, by applying the polishing composition of the present invention, a polished object 10′ may have an ideal polished surface in which remaining of the object to be polished, which has to be polished, is reduced (or completely removed) and/or recesses are suppressed (or no recess has occurred) as illustrated in FIG. 2.

The present invention includes the following aspects and embodiments.
1. A polishing composition comprising colloidal silica; an alkali metal salt; polyalkylene glycol; at least one selected from the group consisting of a cellulose derivative and a polymer compound X; and water, the polishing composition having a pH of 9.0 to 11.5,
the polymer compound X containing a repeating unit represented by the following formula (1):

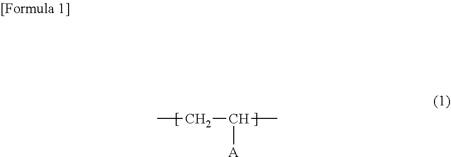

wherein A is a group selected from at least one kind of the followings:

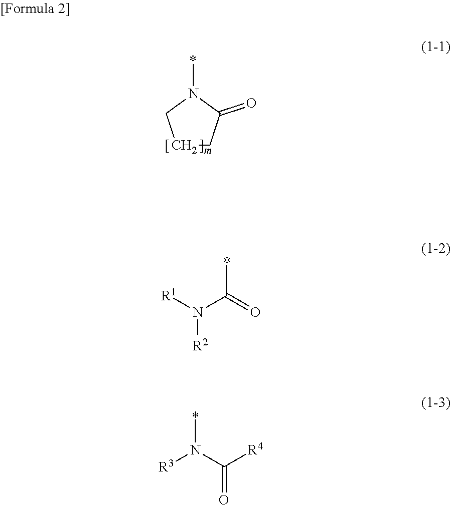

wherein m is an integer of 1 to 5; R¹ to R⁴ are each independently selected from the group consisting of a hydrogen atom and an alkyl group having 1 to 4 carbon atoms, wherein R¹ and R² may form a ring and, in a case where the ring is formed, at least one oxygen atom may be contained in the ring, and wherein R³ and R⁴ may form a ring and, in a case where the ring is formed, at least one oxygen atom may be contained in the ring; and at least one oxygen atom may be contained in a ring in the formula 1-1,
the polymer compound X optionally further containing a repeating unit represented by the following formula (2):

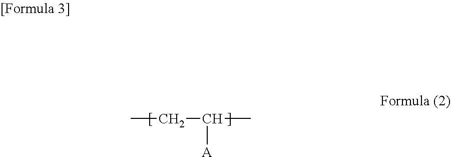

wherein A is a hydroxy group,
(i) wherein the polishing composition is used in a step of polishing a second layer to expose a first layer in an object to be polished including the first layer provided with a recess portion and the second layer formed to fill the inside of the recess portion, and wherein the first layer is selected from the group consisting of a layer having an oxygen-silicon bond or a layer having a nitrogen-silicon bond, and the second layer has a silicon-silicon bond; and/or
(ii) wherein the number of silanol groups in the colloidal silica is 6/nm² or more and 22/nm² or less.
2. The polishing composition according to the “1.”, wherein, in a case where the first layer has an oxygen-silicon bond, a polishing removal rate of the second layer with respect to a polishing removal rate of the first layer is 20 to 40.
3. The polishing composition according to the “1.” or the “2.”, wherein, in a case where the first layer has a nitrogen-silicon bond, the polishing removal rate of the second layer with respect to the polishing removal rate of the first layer is more than 40 and 100 or less.
4. The polishing composition according to any of the “1.” to the “3.”, wherein a pulsed NMR specific surface area of the colloidal silica is 40 m²/g or less.
5. The polishing composition according to any of the “1.” to the “4.”, wherein an average primary particle size of the colloidal silica is more than 70 nm and less than 100 nm.
6. The polishing composition according to any of the “1.” to the “5.”, wherein the alkali metal salt is an alkali metal hydroxide.
7. The polishing composition according to the “6.”, wherein the alkali metal hydroxide is potassium hydroxide.
8. The polishing composition according to any of the “1.” to the “7.”, wherein a transmittance when light whose wavelength is 450 nm is transmitted is more than 0.1% and less than 1% in a case where a concentration of the colloidal silica is 1.5 mass %.
9. A polishing composition consisting essentially of colloidal silica having 6/nm² or more and 22/nm² or less silanol groups; an alkali metal salt; polyalkylene glycol; at least one selected from the group consisting of a cellulose derivative and a polymer compound X; and water,
wherein the polymer compound X contains a repeating unit represented by the following formula (1):

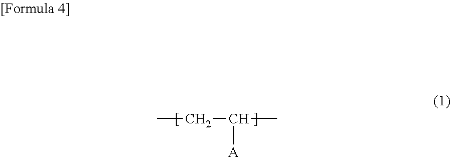

wherein A is a group selected from at least one kind of the followings:

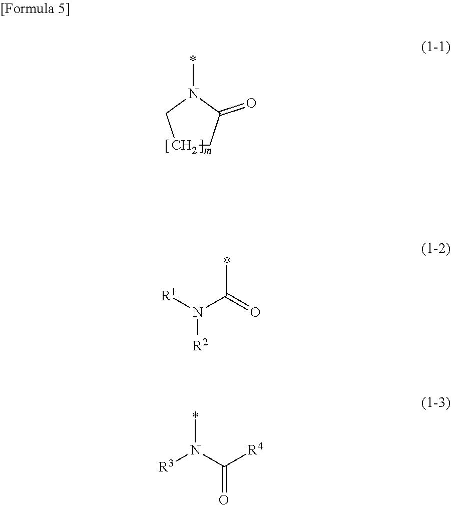

wherein m is an integer of 1 to 5; R¹ to R⁴ are each independently selected from the group consisting of a hydrogen atom and an alkyl group having 1 to 4 carbon atoms, wherein R¹ and R² may form a ring and, in a case where the ring is formed, at least one oxygen atom may be contained in the ring, and wherein R³ and R⁴ may form a ring and, in a case where the ring is formed, at least one oxygen atom may be contained in the ring; and at least one oxygen atom may be contained in a ring in the formula 1-1, wherein the polymer compound X optionally further contains a repeating unit represented by the following formula (2):

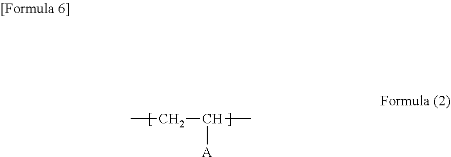

wherein A is a hydroxy group, and
wherein a pH of the polishing composition is 9.0 to 11.5.
10. A polishing composition consisting essentially of colloidal silica having 6/nm² or more and 22/nm² or less silanol groups; an alkali metal salt; polyalkylene glycol; at least one selected from the group consisting of a cellulose derivative and a polymer compound X; an antiseptic agent; and water,
wherein the polymer compound X contains a repeating unit represented by the following formula (1):

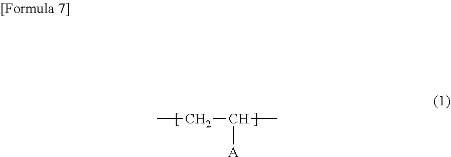

wherein A is a group selected from at least one kind of the followings:

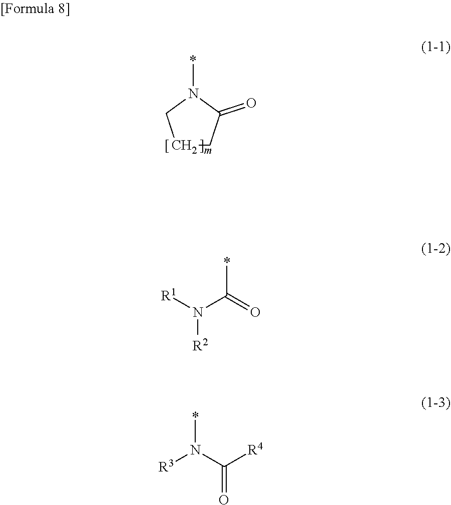

wherein m is an integer of 1 to 5; R¹ to R⁴ are each independently selected from the group consisting of a hydrogen atom and an alkyl group having 1 to 4 carbon atoms, wherein R¹ and R² may form a ring and, in a case where the ring is formed, at least one oxygen atom may be contained in the ring, and wherein R³ and R⁴ may form a ring and, in a case where the ring is formed, at least one oxygen atom may be contained in the ring; and at least one oxygen atom may be contained in a ring in the formula 1-1,
wherein the polymer compound X optionally further contains a repeating unit represented by the following formula (2):

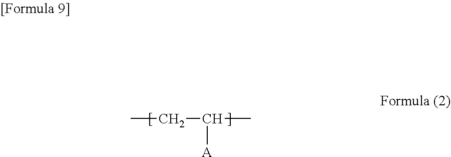

wherein A is a hydroxy group, and
wherein a pH of the polishing composition is 9.0 to 11.5.

### EXAMPLES

The present invention will be described in more detail with the following Examples and Comparative Examples. However, the technical scope of the present invention is not limited only to the following Examples. In the following description, unless otherwise specified, the operation was performed under the conditions of room temperature (25° C.)/relative humidity of 40 to 50% RH.

### <Production of Polishing Composition>

A polishing composition was prepared by mixing abrasive grains, an alkali metal salt, polyalkylene glycol, one of the cellulose derivative and the polymer compound X (described as Additive in Table 1), and water together in accordance with the composition shown in Table 1. For example, the polishing composition of Example 1 contains 1.5 mass % of colloidal silica having a pulsed NMR specific surface area of 23.8 m²/g, 7.9/nm² silanol groups, an average primary particle size of 90 nm, and an average secondary particle size of 220 nm; potassium hydroxide; 40 mass ppm of polyvinylpyrrolidone (PVP) (weight average molecular weight: 4,5000); 10 mass ppm of polyethylene glycol (PEG) (weight average molecular weight: 200); and water, wherein the pH is 10.8.

### [Weight Average Molecular Weight]

In the present specification, for the “weight average molecular weight”, the value of the weight average molecular weight (based on polyethylene glycol) measured by gel permeation chromatography (GPC) may be used. The weight average molecular weight may be measured with the apparatus and under the condition as described below:
GPC apparatus: manufactured by SHIMADZU CORPORATION

$$Model : Prominence + ELSD ( ELSD - LTII )$$

Column: VP-ODS (manufactured by SHIMADZU CORPORATION)
Mobile phase A: MeOH
   B: 1% aqueous solution of acetic acid
Flow rate: 1 mL/minute
Detector: ELSD temp. 40° C.; Gain 8; N₂GAS 350 kPa
Temperature of Oven: 40° C.
Injecting amount: 40 μL

### <Method of Calculating Particle Size>

The average primary particle size of the abrasive grains was calculated from the specific surface area of the abrasive grains measured by the BET method using “Macsorb HM model-1210” manufactured by MOUNTECH Co., Ltd. and the density of the abrasive grains.

The average secondary particle size of the abrasive grains was measured by a dynamic light scattering particle size and particle size distribution apparatus UPA-UT151 manufactured by NIKKISO CO., LTD.

### <Method of Measuring Pulsed NMR Specific Surface Area>

For each of the Examples and Comparative Examples, dispersion liquids were prepared as samples by dispersing abrasive particles (colloidal silica) in water to a concentration of 20 mass %. Table 1 shows the results of measuring the specific surface area under the following measurement conditions using a pulsed NMR particle interface characteristic evaluator (manufactured by Xigo nanotools).
Measurement condition
Bulk relaxation time: 2409 ms
Specific surface relaxivity: 0.00026
Volume ratio of particle to liquid: 0.1136.

### <Method of Calculating Number of Silanol Groups>

The number of silanol groups (unit: number/nm²) per unit surface area of the abrasive grains was calculated by the following method after each parameter was measured or calculated by the following measurement method or calculation method.

More specifically, C in the following formula is the total mass of the abrasive grains, and S in the following formula is the BET specific surface area of the abrasive grains. Further specifically, first, 1.50 g of abrasive grains as a solid content is collected in a 200 ml beaker, 100 ml of pure water is added to form a slurry, and then 30 g of sodium chloride is added to dissolve the slurry. Next, 1 N hydrochloric acid is added to adjust the pH of the slurry to 3.0 to 3.5, and then pure water is added until the slurry reaches 150 ml.

For this slurry, the pH is adjusted to 4.0 using 0.1 N sodium hydroxide at 25° C. using an automatic titrator (COM-1700 manufactured by HIRANUMA Co., Ltd.), and the volume V [L] of the 0.1 N sodium hydroxide solution required to increase the pH from 4.0 to 9.0 is measured by pH titration. The average silanol group density (the number of silanol groups) can be calculated by the following formula.

$$ρ = ( c \times V \times {N}_{A} ) / ( C \times S )$$

In the above formula,
ρ represents an average silanol group density (number of silanol groups) (number/nm²);
c represents a concentration (mol/L) of the sodium hydroxide solution used for titration;
V represents a volume (L) of the sodium hydroxide solution required to increase the pH from 4.0 to 9.0;
N_{A} represents the Avogadro constant (number/mol);
C represents a total mass (solid content) (g) of the abrasive grains; and
S represents a weighted average value (nm²/g) of the BET specific surface area of the abrasive grains. The BET specific surface area is a value of the specific surface area of the abrasive grains measured by the BET method using “Macsorb HM model-1210” manufactured by MOUNTECH Co., Ltd.

### <Measurement of pH of Polishing Composition>

A value obtained by performing three-point calibration using a glass electrode type hydrogen ion concentration indicator (Model: F-23 manufactured by HORIBA, Ltd.), and a standard buffer solutions (a phthalate pH buffer solution at pH: 4.01 (25° C.), a neutral phosphate pH buffer solution at pH: 6.86 (25° C.), and a carbonate pH buffer solution at pH: 10.01 (25° C.)), placing a glass electrode in the polishing composition, and then obtaining a stabilized value after 2 minutes or longer was measured as the pH of the polishing composition.

### <Measurement of Transmittance of Polishing Composition>

The transmittance of the polishing composition was measured by irradiating the polishing composition with light whose wavelength is 450 nm using an ultraviolet-visible spectrophotometer (UV-2450 manufactured by SHIMADZU CORPORATION). The results thereof were shown in Table 1.

### <Measurement of Polishing Removal Rate>

The surface of the object to be polished was polished using the polishing composition under the following polishing conditions. A silicon wafer (300 mm, blanket wafer) with a polysilicon (Poly-Si) film having a thickness of 5000 Å formed on the surface thereof, a silicon wafer (300 mm, blanket wafer) with a P-TEOS (TEOS film (silicon dioxide film) formed by plasma CVD) film having a thickness of 10000 Å formed on the surface thereof, and a silicon wafer (300 mm, blanket wafer) with a silicon nitride (SiN) film having a thickness of 3000 Å formed on the surface thereof were each used as the object to be polished.

### (Polishing Conditions)

Polishing apparatus: CMP one-side polishing apparatus for 300 mm, Reflexion LK manufactured by Applied Materials, Inc.; Pad: hard polyurethane pad, IC1010 manufactured by Nitta Haas Incorporated
Polishing pressure: 1.5 psi (1 psi=6894.76 Pa, hereinafter the same)
Number of revolutions of polishing table: 70 rpm
Number of revolutions of carrier: 70 rpm
Supply of polishing composition: flow-through
Supply amount of polishing composition: 200 ml/min
Polishing time: 60 seconds

The polishing removal rate was measured by determining the thickness with an optical film thickness measurement apparatus (RE-3500: manufactured by SCREEN Holdings Co., Ltd.) and then dividing (the thickness before polishing)−(the thickness after polishing) by the polishing time. The ratio of the polishing removal rate (Å/min) of the polysilicon film with respect to the polishing removal rate (Å/min) of the P-TEOS film was calculated as a selectivity. The ratio of the polishing removal rate (Å/min) of the polysilicon film to the polishing removal rate (Å/min) of the SiN film was calculated as a selectivity. The results thereof were shown in Table 2.

### <Recess Evaluation of Polysilicon>

The pattern wafer having a polysilicon film was subjected to polishing under the [Condition 1] below using the polishing composition described in Table 1. As illustrated in FIG. 1, the pattern wafer is produced by forming a recess portion by laminating a P-TEOS film (1000 Å) or a silicon nitride film (SiN film) on the Si substrate and then digging a trench having a depth of 1000 Å, and thereafter, laminating a polysilicon film (2000 Å) thereon to fill the recess portion.

The polishing of the pattern wafer with a polysilicon film was terminated after further continuation by a time corresponding to 40% of the polishing time until the end point signal was detected after the end point signal was detected. In this manner, a step of further polishing the first layer (P-TEOS film) after the first layer (P-TEOS film or silicon nitride film (SiN film)) is exposed was performed.

In the isolated wiring part having a width of 10 μm on the surface of the pattern wafer, the recess amount was measured with an atomic force microscope (product name: InSight CAP; manufactured by Bruker). The recess amount thus obtained was evaluated according to the following criteria.

### [Condition 1]

Polishing apparatus: CMP one-side polishing apparatus for 300 mm, Reflexion LK manufactured by Applied Materials, Inc.
Pad: Hard polyurethane pad IC1010 manufactured by Nitta Haas Incorporated
Polishing pressure: 1.5 psi (1 psi=6894.76 Pa, hereinafter the same)
Number of revolutions of polishing table: 70 rpm
Number of revolutions of carrier: 70 rpm
Supply of polishing composition: flow-through
Supply amount of polishing composition: 200 ml/minute
Polishing time: 1 minute

### [Recess Amount]

The recess was determined according to the following four-stage criteria. A and x are practically unacceptable. The results thereof were shown in Table 2.
⊚: less than 50 nm
∘: 50 nm or more and less than 75 nm
Δ: 75 nm or more and less than 100 nm
x: 100 nm or more
   <Remaining of Polysilicon (Remaining after Polishing)>

The film thickness of the polysilicon remaining on the P-TEOS film after polishing was measured using an optical film thickness measurement apparatus (ASET-f5x: manufactured by KLA Corporation). The measured film thickness was determined to be remaining after polishing, and then was determined according to the following four-stage criteria. A and x are practically unacceptable. The results thereof were shown in Table 2.
⊚: less than 5 Å
∘: 5 Å or more and less than 10 Å
Δ: 10 Å or more and less than 20 Å
x: 20 Å or more
   [Measurement of Metal Impurities (the Number of Atoms after Cleaning)]

The polished silicon wafer with a P-TEOS film was cleaned for 60 seconds using a PVA brush in a cleaning unit while being splashed with deionized water (DIW). Thereafter, drying was performed with a spin dryer for 30 seconds. The concentrations of Na, K, and Li on the surface of the wafer after cleaning were measured using a total reflection X-ray fluorescence spectrometer (spectrometer name: TREX-610T) manufactured by TECHNOS Kabushiki Kaisha. The results thereof were shown in Table 2.

TABLE 1

| | Abrasive grains (colloidal silica) | | | | | | |
|---|---|---|---|---|---|---|---|
| | | | Pulsed | | | | |
| | | Average | NMR | Silanol | | Additive | |
| | | primary | specific | group | | | Weight |
| | | particle | surface | density | Alkali | | average |
| | Concentration | size | area | [number/ | metal | | molecular |
| | [wt %] | [nm] | [m²/g] | nm²] | salt | Compound | weight |
| E 1 | 1.5 | 90 | 23.8 | 7.9 | KOH | PVP | 45000 |
| E 2 | 1.5 | 90 | 23.8 | 7.9 | KOH | PVP | 45000 |
| E 3 | 1.5 | 90 | 23.8 | 7.9 | KOH | PVP | 45000 |
| E 4 | 1.5 | 90 | 23.8 | 7.9 | KOH | PVP | 45000 |
| E 5 | 1.5 | 90 | 23.8 | 7.9 | KOH | HEC | 1200000 |
| E 6 | 1.5 | 90 | 23.8 | 7.9 | KOH | PVA-PVP | 80000- |
| | | | | | | | 80000 |
| E 7 | 1.5 | 70 | 31.9 | 6.6 | KOH | PVP | 45000 |
| E 8 | 1.5 | 100 | 26.1 | 17.5 | KOH | PVP | 45000 |
| E 9 | 1.5 | 100 | 23.8 | 7.9 | KOH | PVP | 45000 |
| E 10 | 1.5 | 100 | 23.8 | 7.9 | KOH | PVP | 45000 |
| E 11 | 1.5 | 100 | 23.8 | 7.9 | NaOH | PVP | 45000 |
| E 12 | 1.5 | 100 | 23.8 | 7.9 | K₂CO₃ | PVP | 45000 |
| E 13 | 1.5 | 100 | 23.8 | 7.9 | LiOH | PVP | 45000 |
| E 14 | 1.5 | 90 | 23.8 | 7.9 | KOH | PVP | 45000 |
| CE 1 | 1.5 | 90 | 23.8 | 7.9 | KOH | — | — |
| CE 2 | 1.5 | 90 | 23.8 | 7.9 | KOH | PVP | 45000 |
| CE 3 | 1.5 | 90 | 23.8 | 7.9 | KOH | HEC | 1200000 |
| CE 4 | 1.5 | 90 | 23.8 | 7.9 | KOH | PVA-PVP | 80000- |
| | | | | | | | 80000 |
| CE 5 | 1.5 | 90 | 23.8 | 7.9 | KOH | — | — |
| CE 6 | 1.5 | 30 | 65.7 | 5.5 | KOH | PVP | 45000 |
| CE 7 | 1.5 | 60 | 20.1 | 1.5 | KOH | PVP | 45000 |
| CE 8 | 1.5 | 12 | 70.5 | 3.1 | KOH | PVP | 45000 |
| CE 9 | 1.5 | 25 | 48.7 | 3.7 | KOH | PVP | 45000 |
| CE 10 | 1.5 | 35 | 29.9 | 3.4 | KOH | PVP | 45000 |
| CE 11 | 1.5 | 39 | 35.2 | 1.6 | KOH | PVP | 45000 |
| CE 12 | 1.5 | 55 | 36.6 | 5.9 | KOH | PVP | 45000 |
| CE 13 | 1.5 | 220 | 21.9 | 23.8 | KOH | PVP | 45000 |
| CE 14 | 1.5 | 90 | 23.8 | 2.5 | KOH | PVP | 45000 |
| CE 15 | 1.5 | 90 | 23.8 | 7.9 | KOH | PVP | 45000 |

| | | Polyalkylene glycol | | | | |
|---|---|---|---|---|---|---|
| | | | Weight | | | |
| | Additive | | average | | | |
| | Concentration | | molecular | Concentration | | Transmittance |
| | [mass ppm] | Compound | weight | [mass ppm] | pH | [%] |
| E 1 | 40 | PEG | 200 | 10 | 10.8 | 0.25 |
| E 2 | 40 | PEG | 200 | 40 | 10.8 | 0.24 |
| E 3 | 40 | PEG | 200 | 100 | 10.8 | 0.23 |
| E 4 | 40 | PPG | 200 | 40 | 10.8 | 0.21 |
| E 5 | 40 | PEG | 200 | 40 | 10.8 | 0.18 |
| E 6 | 40 | PEG | 200 | 40 | 10.8 | 0.19 |
| E 7 | 40 | PEG | 200 | 40 | 10.8 | 0.76 |
| E 8 | 40 | PEG | 200 | 40 | 10.8 | 0.15 |
| E 9 | 40 | PEG | 200 | 40 | 9.5 | 0.18 |
| E 10 | 40 | PEG | 200 | 40 | 10.0 | 0.19 |
| E 11 | 40 | PEG | 200 | 40 | 10.8 | 0.23 |
| E 12 | 40 | PEG | 200 | 40 | 10.8 | 0.21 |
| E 13 | 40 | PEG | 200 | 40 | 10.8 | 0.21 |
| E 14 | 40 | PEG | 200 | 40 | 11.2 | 0.23 |
| CE 1 | — | — | — | — | 10.8 | 0.26 |
| CE 2 | 40 | — | — | — | 10.8 | 0.25 |
| CE 3 | 40 | — | — | — | 10.8 | 0.21 |
| CE 4 | 40 | — | — | — | 10.8 | 0.22 |
| CE 5 | — | PEG | 200 | 40 | 10.8 | 0.26 |
| CE 6 | 40 | PEG | 200 | 40 | 10.8 | 58 |
| CE 7 | 40 | PEG | 200 | 40 | 10.8 | 0.53 |
| CE 8 | 40 | PEG | 200 | 40 | 10.8 | 92 |
| CE 9 | 40 | PEG | 200 | 40 | 10.8 | 65 |
| CE 10 | 40 | PEG | 200 | 40 | 10.8 | 55 |
| CE 11 | 40 | PEG | 200 | 40 | 10.8 | 46 |
| CE 12 | 40 | PEG | 200 | 40 | 10.8 | 1.53 |
| CE 13 | 40 | PEG | 200 | 40 | 10.8 | 0.03 |
| CE 14 | 40 | PEG | 200 | 40 | 10.8 | 0.23 |
| CE 15 | 40 | PEG | 200 | 40 | 7.5 | 0.25 |

E: Example
CE: Comparative Example
PVP: polyvinylpyrrolidone
PVA-PVP: Graft copolymer of vinylpyrrolidone and vinyl alcohol (PVA:PVP (molar ratio) = 5:2).
The main chain is a vinyl alcohol polymer (the weight average molecular weight: 80000), and a vinylpyrrolidone polymer (the weight average molecular weight of the whole side chain part: 80000) is bonded thereto as a side chain.
PEG: polyethylene glycol
PPG: polypropylene glycol

TABLE 2

| | | | | Selectivity | | | | | | Number of | | |
|---|---|---|---|---|---|---|---|---|---|---|---|---|
| | | | | of polishing | | | | | | atoms after | | |
| | Polishing removal rate | | | removal rate | | Poly-Si/SiN | | Poly-Si/TEOS | | cleaning | | |
| | poly-Si | SiN | SiO₂ | Poly- | Poly- | | Remaining | | Remaining | (×10¹⁰/cm²) | | |
| | [Å/min] | [Å/min] | [Å/min] | Si/SiN | Si/TEOS | Recess | of poly-Si | Recess | of poly-Si | Na | K | Li |
| E 1 | 1922 | 27 | 85 | 71 | 23 | ⊚ | ◯ | ⊚ | ◯ | 0.02 | 16 | 0 |
| E 2 | 1901 | 26 | 84 | 73 | 23 | ⊚ | ⊚ | ⊚ | ⊚ | 0.02 | 18 | 0 |
| E 3 | 1882 | 25 | 83 | 75 | 23 | ⊚ | ⊚ | ⊚ | ⊚ | 0.03 | 20 | 0 |
| E 4 | 1653 | 24 | 82 | 69 | 20 | ⊚ | ◯ | ⊚ | ◯ | 0.03 | 17 | 0 |
| E 5 | 1726 | 27 | 83 | 64 | 21 | ◯ | ◯ | ◯ | ◯ | 0.02 | 16 | 0 |
| E 6 | 1701 | 26 | 85 | 65 | 20 | ◯ | ⊚ | ⊚ | ⊚ | 0.03 | 18 | 0 |
| E 7 | 1820 | 23 | 49 | 79 | 37 | ⊚ | ◯ | ⊚ | ◯ | 0.03 | 19 | 0 |
| E 8 | 1900 | 27 | 89 | 70 | 21 | ◯ | ⊚ | ◯ | ⊚ | 0.03 | 16 | 0 |
| E 9 | 1508 | 19 | 74 | 79 | 20 | ⊚ | ◯ | ⊚ | ◯ | 0.02 | 17 | 0 |
| E 10 | 1728 | 23 | 79 | 75 | 22 | ⊚ | ◯ | ⊚ | ◯ | 0.02 | 17 | 0 |
| E 11 | 1924 | 28 | 86 | 69 | 22 | ⊚ | ⊚ | ⊚ | ⊚ | 37 | 16 | 0 |
| E 12 | 1903 | 27 | 67 | 70 | 28 | ⊚ | ⊚ | ⊚ | ⊚ | 0.03 | 23 | 0 |
| E 13 | 1914 | 28 | 86 | 68 | 22 | ⊚ | ⊚ | ⊚ | ⊚ | 0 | 0 | 36 |
| E 14 | 2354 | 31 | 89 | 76 | 26 | ◯ | ⊚ | ◯ | ⊚ | 0.02 | 20 | 0 |
| CE 1 | 1911 | 29 | 88 | 66 | 22 | X | ⊚ | Δ | ⊚ | 0.02 | 18 | 0 |
| CE 2 | 1950 | 28 | 86 | 70 | 23 | ⊚ | X | ⊚ | X | 0.03 | 17 | 0 |
| CE 3 | 1798 | 26 | 85 | 69 | 21 | ◯ | X | ◯ | X | 0.03 | 19 | 0 |
| CE 4 | 1723 | 26 | 84 | 66 | 21 | ⊚ | X | ⊚ | X | 0.02 | 18 | 0 |
| CE 5 | 1902 | 27 | 88 | 70 | 22 | X | ⊚ | Δ | ⊚ | 0.02 | 18 | 0 |
| CE 6 | 1757 | 18 | 63 | 100 | 28 | ⊚ | Δ | ⊚ | Δ | 0.02 | 20 | 0 |
| CE 7 | 1384 | 23 | 85 | 60 | 16 | ⊚ | X | ⊚ | X | 0.03 | 18 | 0 |
| CE 8 | 1092 | 7 | 31 | 147 | 35 | ⊚ | X | ⊚ | X | 0.02 | 19 | 0 |
| CE 9 | 1287 | 12 | 40 | 107 | 32 | ⊚ | X | ⊚ | X | 0.02 | 18 | 0 |
| CE 10 | 1482 | 16 | 61 | 94 | 24 | ⊚ | X | ⊚ | X | 0.03 | 16 | 0 |
| CE 11 | 1464 | 17 | 64 | 88 | 23 | ⊚ | X | ⊚ | X | 0.02 | 18 | 0 |
| CE 12 | 1579 | 20 | 70 | 77 | 22 | ⊚ | Δ | ⊚ | Δ | 0.02 | 19 | 0 |
| CE 13 | 2145 | 42 | 137 | 51 | 16 | Δ | ⊚ | Δ | ⊚ | 0.03 | 21 | 0 |
| CE 14 | 1947 | 23 | 86 | 84 | 23 | ⊚ | X | ⊚ | X | 0.02 | 17 | 0 |
| CE 15 | 480 | 12 | 34 | 40 | 14 | ⊚ | X | ⊚ | X | 0.02 | 18 | 0 |

### DISCUSSION

The polishing compositions of Examples each have reduced remaining of polysilicon, which has to be polished, and have been able to suppress recesses. In contrast, in the polishing composition of each of Comparative Examples, remaining of polysilicon, which had to be polished, had occurred or recesses had been promoted, as illustrated in FIGS. 3 to 5.

The contrast among Examples 1 to 3 shows that the mass concentration of the polyalkylene glycol in the polishing composition is preferably 40 ppm or more from the viewpoint of suppressing remaining of polysilicon. The contrast between Examples 2 and 4 shows that, among the polyalkylene glycols, PEG is preferable from the viewpoint of suppressing remaining of polysilicon. The contrast between Examples 2 and 5 shows that PVP is more preferable than HEC from the viewpoint of suppressing remaining of polysilicon and occurrence of recesses. The contrast between Examples 2 and 6 shows that, among the polymer compounds X, PVP is preferable from the viewpoint of suppressing occurrence of recesses. The contrast between Example 2 and Examples 7 and 8 shows that the number of silanol groups of the colloidal silica is preferably more than 6.6/nm² and less than 17.5/nm² from the viewpoint of suppressing remaining of polysilicon and occurrence of recesses. The contrast between Example 2 and Examples 9 and 10 shows that the pH of the polishing composition is preferably more than 10.0 from the viewpoint of suppressing remaining of polysilicon. The contrast between Example 2 and Examples 11 to 13 shows that, as an alkali metal salt, an alkali metal hydroxide is more preferable than an alkali metal carbonate from the viewpoint of reducing the remaining metal. It is also shown that, as an alkali metal, potassium is particularly preferable from the viewpoint of reducing the remaining metal. The contrast between Example 2 and Example 14 shows that the pH of the polishing composition is preferably less than 11.2 from the viewpoint of suppressing occurrence of recesses.

In contrast, the polishing compositions of Comparative Examples do not achieve both of reducing remaining of polysilicon, which has to be polished, and suppressing recesses. More specifically, the result of Comparative Example 1 shows that occurrence of recesses increases when one of the cellulose derivative and the polymer compound X (additive) and the polyalkylene glycol are not contained. The results of Comparative Examples 2 to 4 show that remaining of polysilicon increases when the polyalkylene glycol is not contained. The result of Comparative Example 5 shows that occurrence of recesses increases when at least one selected from the group consisting of the cellulose derivative and the polymer compound X is not contained. The results of Comparative Examples 6 to 12 and 14 show that remaining of polysilicon increases when the number of silanol groups of the colloidal silica is less than 6/nm². The result of Comparative Example 13 shows that occurrence of recesses increases when the number of silanol groups of the colloidal silica is more than 22/nm². The result of Comparative Example 15 shows that remaining of polysilicon increases when the pH of the polishing composition is less than 9.0.

### REFERENCE SIGNS LIST

1 First layer
2 Second layer
2a Recess
2b Remaining of second layer which has to be polished
10 Object to be polished
10′ Polished object

The present application is based on Japanese Patent Application No. 2024-081896, filed on May 20, 2024, the entire contents of which being herein incorporated by reference.

What is claimed is:

1. A polishing composition comprising colloidal silica; an alkali metal salt; polyalkylene glycol; at least one selected from the group consisting of a cellulose derivative and a polymer compound X; and water, the polishing composition having a pH of 9.0 to 11.5,
the polymer compound X containing a repeating unit represented by the following formula (1): 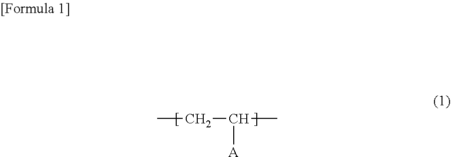
wherein A is a group selected from at least one kind of the followings: 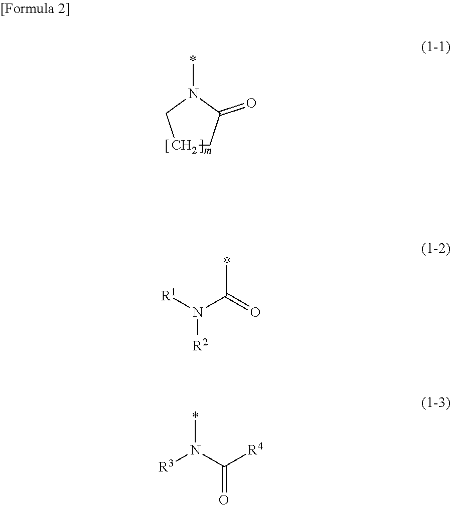
wherein m is an integer of 1 to 5; R¹ to R⁴ are each independently selected from the group consisting of a hydrogen atom and an alkyl group having 1 to 4 carbon atoms, wherein R¹ and R² may form a ring and, in a case where the ring is formed, at least one oxygen atom may be contained in the ring, and wherein R³ and R⁴ may form a ring and, in a case where the ring is formed, at least one oxygen atom may be contained in the ring; and at least one oxygen atom may be contained in a ring in the formula 1-1,
the polymer compound X optionally further containing a repeating unit represented by the following formula (2): 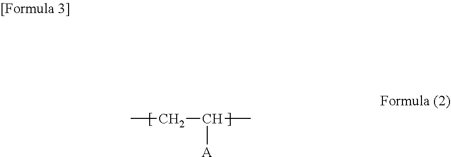
wherein A is a hydroxy group,
(i) wherein the polishing composition is used in a step of polishing a second layer to expose a first layer in an object to be polished including the first layer provided with a recess portion and the second layer formed to fill the inside of the recess portion, and wherein the first layer is selected from the group consisting of a layer having an oxygen-silicon bond or a layer having a nitrogen-silicon bond, and the second layer has a silicon-silicon bond; and/or
(ii) wherein the number of silanol groups in the colloidal silica is 6/nm² or more and 22/nm² or less.

2. The polishing composition according to claim 1, wherein, in a case where the first layer has an oxygen-silicon bond, a polishing removal rate of the second layer with respect to a polishing removal rate of the first layer is 20 to 40.

3. The polishing composition according to claim 1, wherein, in a case where the first layer has a nitrogen-silicon bond, a polishing removal rate of the second layer with respect to a polishing removal rate of the first layer is more than 40 and 100 or less.

4. The polishing composition according to claim 1, wherein a pulsed NMR specific surface area of the colloidal silica is 40 m²/g or less.

5. The polishing composition according to claim 1, wherein an average primary particle size of the colloidal silica is more than 70 nm and less than 100 nm.

6. The polishing composition according to claim 1, wherein the alkali metal salt is an alkali metal hydroxide.

7. The polishing composition according to claim 6, wherein the alkali metal hydroxide is potassium hydroxide.

8. The polishing composition according to claim 1, wherein a transmittance when light whose wavelength is 450 nm is transmitted is more than 0.1% and less than 1% in a case where a concentration of the colloidal silica is 1.5 mass %.

9. A polishing composition consisting essentially of colloidal silica having 6/nm² or more and 22/nm² or less silanol groups; an alkali metal salt; polyalkylene glycol; at least one selected from the group consisting of a cellulose derivative and a polymer compound X; and water,
wherein the polymer compound X contains a repeating unit represented by the following formula (1): 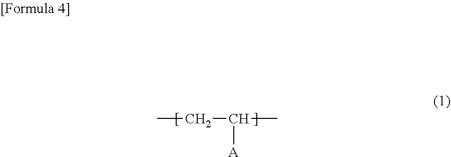
wherein A is a group selected from at least one kind of the followings: 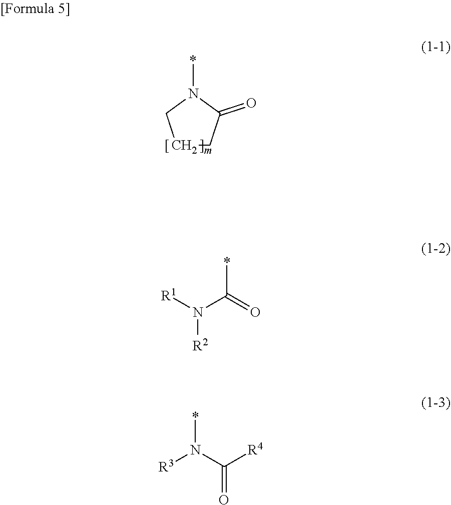
wherein m is an integer of 1 to 5; R¹ to R⁴ are each independently selected from the group consisting of a hydrogen atom and an alkyl group having 1 to 4 carbon atoms, wherein R¹ and R² may form a ring and, in a case where the ring is formed, at least one oxygen atom may be contained in the ring, and wherein R³ and R⁴ may form a ring and, in a case where the ring is formed, at least one oxygen atom may be contained in the ring; and at least one oxygen atom may be contained in a ring in the formula 1-1,
wherein the polymer compound X optionally further contains a repeating unit represented by the following formula (2): 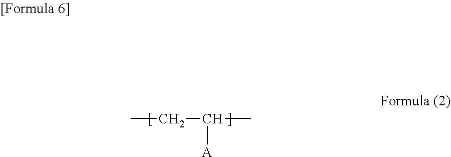
wherein A is a hydroxy group, and
wherein a pH of the polishing composition is 9.0 to 11.5.

10. A polishing composition consisting essentially of colloidal silica having 6/nm² or more and 22/nm² or less silanol groups; an alkali metal salt; polyalkylene glycol; at least one selected from the group consisting of a cellulose derivative and a polymer compound X; an antiseptic agent; and water,
wherein the polymer compound X contains a repeating unit represented by the following formula (1): 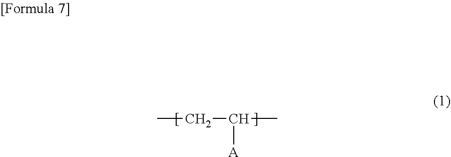
wherein A is a group selected from at least one kind of the followings: 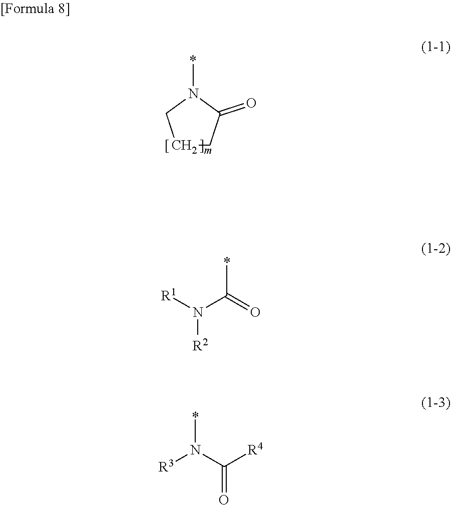
wherein m is an integer of 1 to 5; R¹ to R⁴ are each independently selected from the group consisting of a hydrogen atom and an alkyl group having 1 to 4 carbon atoms, wherein R¹ and R² may form a ring and, in a case where the ring is formed, at least one oxygen atom may be contained in the ring, and wherein R³ and R⁴ may form a ring and, in a case where the ring is formed, at least one oxygen atom may be contained in the ring; and at least one oxygen atom may be contained in a ring in the formula 1-1,
wherein the polymer compound X optionally further contains a repeating unit represented by the following formula (2): 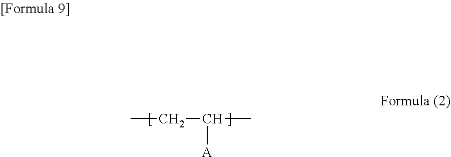
wherein A is a hydroxy group, and
wherein a pH of the polishing composition is 9.0 to 11.5.
